(19) United States
(12) Patent Application Publication
(10) Pub. No.: US 2007/0009347 A1
(43) Pub. Date: Jan. 11, 2007

(54) Generate electricity by concentrating wind, by moving transportation, by flowing of liquid, by sun burning, etc in utility of housing, industry, etc

(76) Inventor: Henri Duong, Alhambra, CA (US)

Correspondence Address: Henri Duong, 316 1/2 E Glendon way, Alhambra, CA, 91801, US

(21) Appl. No.: 11/175,645

(22) Filed: Jul. 6, 2005

(51) Int. Cl. F03B 15/06

(52) U.S. Cl. 415/2.1

(57) ABSTRACT

Generate electricity by concentrating wind, by water pressure, by sun burning, by moving transportation, etc to obtain free electricity in utility of housing, industrial domains, etc to be a project profitable to all of us.

### CROSS-REFERENCE TO RELATED APPLICATIONS

Disclosure Document Deposit Request; former Disclosure Document No: 560438 date Sep. 10, 2004 PTO-1652 (8/99)

### STATEMENT REGARDING FEDERALLY SPONSORED RESEARCH OR DEVELOPMENT

“Not Applicable”

### REFERENCE TO A MICROFICHE APPENDIX

“Not Applicable”

### BACKGROUND OF THE INVENTION

Electricity: Generating electricity by propeller blade with dynamo is to install blades in nature letting wind blowing, wind will blow at both high and low sides of blade “a” shown on FIG. 2 at a time thus producing anti-rotating force as propeller blade rotates either left or right side but not to both sides that traditional method will technically weaken revolving speed.

My discovery is how to let wind blowing at propeller blade eliminating anti-rotating force b3; half covered blade b1, hidden part b2 and partial cover blade b2c retain important elements to accelerate propeller blade speed, rotating blade has to be installed on horizontal spin b3a equipping with dynamo obtaining wind blown from at least 4 sides to generate electricity increasingly several times more than usual on FIG. 2.

Second discovery is to install half covered blades with speed acceleration blades in all moving transportations and/or equivalents to rotate dynamos or equivalents at full speed to generate electricity for common use in housing, industrial domains.

Generate electricity by water solely does depending natural water on flowing from mountain, my discoveries are to use flowing of water in channels or/and equivalents at/below surface level of water from ocean, sea, lake, river, pool, water containers, etc to rotate dynamos to generate electricity everywhere, further discoveries are to use solar shining under magnifying glass focus burning on metal etc as burning coals, to use agricultural products of overproduction burning, to use rubber plants of all sorts burning, to use trash burning and to use burning of active volcano generating electricity for free.

### BRIEF SUMMARY OF THE INVENTION

Advantages of discovery are:

to use half and/or partly covered propeller blades by concentrating blowing wind rotating dynamos to generate electricity increasingly everywhere,

to use half, partly covered propeller blades with speed acceleration blades on circle frame, in moving transportation rotating dynamos at full speed to generate electricity in utility of housing, industry, etc,

to use half and/or partly covered propeller blades by flowing of water, air flowing rotating dynamos to generate electricity everywhere for free,

to produce electricity by burning agricultural products of overproduction, rubber plants of all sorts, trash for free,

to produce electricity and to run transportation of all kinds by using alcohol, spirits, oil of all sorts from agricultural products replacing gasoline as energy costing less, cutting freight, producing locally in most countries,

to produce electricity by burning of sun, of active volcano for free,

to produce electricity by expansion of land, removing upper parts of highlands for agricultural energy.

The invention composes of electricity, half covered propeller blades, partly covered propeller blades of all forms, speed acceleration blades, all kinds of transportations and/or equivalents; all vehicles, trains, underground trains, trolleys, automobiles, cars, trucks, buses, vans, engine-vehicles, motor-vehicles, motorcycles, aircraft, helicopters, space rockets, ships, fleet, submarines, etc, propeller blades & blade covers of all sorts; b1, b1a, b2, b2a, b2b, b2c, b3; without causing reverse rotating force of propeller blades, b3a; horizontal spin placing of blades, combination blades, all generators: b4, b4a, b5, b6, b7, b8, b9, b10, b11, b12, b13, b13a, b13b, b13c, b13d, b14, b15, b16, b16a, b17, b18, b18a, b18b, b18b-1, b18b-2, b18c, b18c-1, b18c-2, b19, b19a, b19a-1, b19b, b19c in FIG. 1 to FIG. 44, FIG. 45 to FIG. 56, circle frames, generator train, generator wagon, energy trolley, motors, dynamos, generators, transformers, bearings, frames, V-belts, pulleys, channels, springs, electric wires, conductors, electric wire channels, isolating covers, connectors, railways, electric current, head lamps, bars, rollers, cables, frame, magnetic rolling unit, top channel, traffic street, magnetic force, bearing rollers, magnetic polarized lighting or equivalent technical skill, pumps, water, liquid pressure, deep water pressure, air pressure, below water surface level, water, liquid, channels, drains, tubes, pipes, hoses etc, ocean, sea, river, lake, pool, water containers, sewer, sea border, passing of water, filters, valves, control boxes, axis, gears, spindles, wheels, chains, drives, gear oil boxed, (engine type) thermostats, sun shining, magnifying glass, metals, mirrors, blades, wind, sun, trash, accessories, alcohol, grain, molasses, spirits, firewater, liquor, oil of all sorts, rubber plants of all sorts, agricultural products, population, burning plant, chimney, plant, sediment, fertilizer, plants, hot pepper powder and liquid or any other similar equivalents, coal mine, coal, electric power (rolling) station, active volcano, land, soil, sands, coast, territories, mountains, states, agriculture, energy, agricultural energy, flammable liquid, upper parts of highlands, contents, illustrations, process of making the invention.

### BRIEF DESCRIPTION OF THE SEVERAL VIEWS OF THE DRAWING

FIG. 1; Generator b4, without reverse spin force blown from all sides

FIG. 2; Blowing system without reverse rotating force

FIG. 3; b3a, horizontal spin placing

FIG. 4; b2a, propeller blades

FIG. 5; b2b, forms of propeller blades

FIG. 6; b1, propeller blades and covers

FIG. 7; b1a, propeller blades & b. covers (of water flowing)

FIG. 8; Device fixing on any electric pole

FIG. 9; Generator b4a, extension of G. b4

FIG. 10; Generator b5, top blade spin, No Reverse Spin Force (N R S F)

FIG. 11; Generator b6, blowing top blade spin of N R S F

FIG. 12; Generator b7, blowing multiple sides of N R S F

FIG. 13; Generator b8, centralizing wind of N R S F

FIG. 14; Generator b9, centralizing wind blowing multiple sides of N R S F

FIG. 15; Generator b10, multiple blowing cycle

FIG. 16; Generator b11, multiple blowing cycle-2

FIG. 17; Generator b12, top opening spin, multiple blowing spin cycle

FIG. 18; Sorts of propeller blades

FIG. 19; Generate electricity on circle frame

FIG. 20; Generator b13, generating electricity on train

FIG. 21; Generator b13a, generating electricity on train wagon

FIG. 22; Generator b13b, generating electricity wagon train

FIG. 23; Distance between 2 trains b13c

FIG. 24; Front view of train b13d

FIG. 25; Generator b14, comb. blades of all sorts on energy trolley

FIG. 26; Generator b15, magnetic rolling unit

FIG. 27; Generator b16, dynamo outside, half covered blade spin in channel

FIG. 28; Generator b16a, half covered blades spin in channel

FIG. 29; Generator b17, up wind blowing, down water flowing

FIG. 30; Extendable equipments

FIG. 31; Generator b18, unit to be installed between pipes

FIG. 32; Generator b18a, device to be installed between pipes

FIG. 33; Generator b18b, combination to be installed between pipes

FIG. 34; Generator b18b1, network of multiple dynamos

FIG. 35; Generator b18b2, horizontal network of multiple dynamos

FIG. 36; Generator b18c, extendable device to be installed between pipes

FIG. 37; Generator b18c1, generator network

FIG. 38; Generator b18c2, horizontal generator network

FIG. 39; View of generator b18b1

FIG. 40; Generator b19, partial covered blades on flowing river

FIG. 41; Generator b19a, combination on flowing river

FIG. 42; Generator b19a-1, on flowing river network

FIG. 43; Generator b19b, multiple partial covered blades on flowing river

FIG. 44; Generator b19c, partial covered blades in channel

FIG. 45; Generate electricity by water pumping

FIG. 46; Generate electricity below water surface

FIG. 47; Generate electricity below water surface network

FIG. 48; Generate electricity under pressure of deep water

FIG. 49; Generate electricity through water channel

FIG. 50; Generate electricity by blowing, flowing, floating

FIG. 51; Generate electricity through air blowing channel

FIG. 52; Generate electricity by solar burning

FIG. 53; Heat by solar energy

FIG. 54; Energy diagram-1

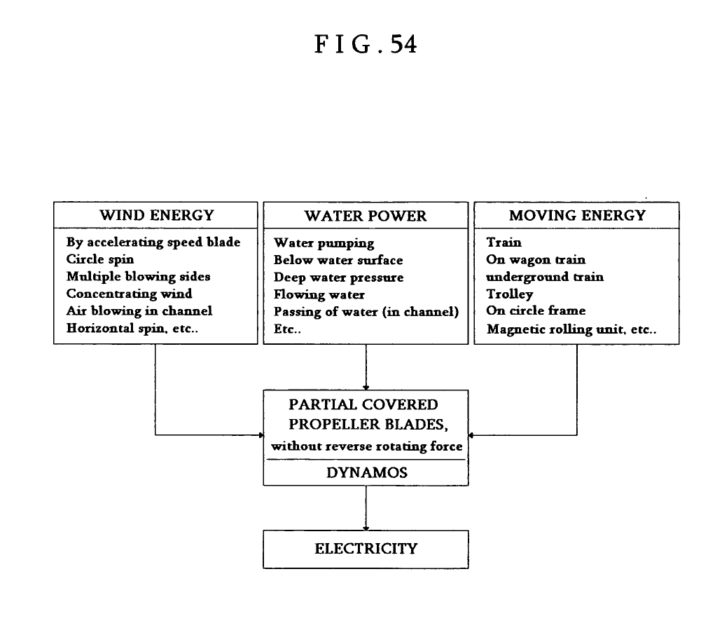

FIG. 55; Energy diagram-2

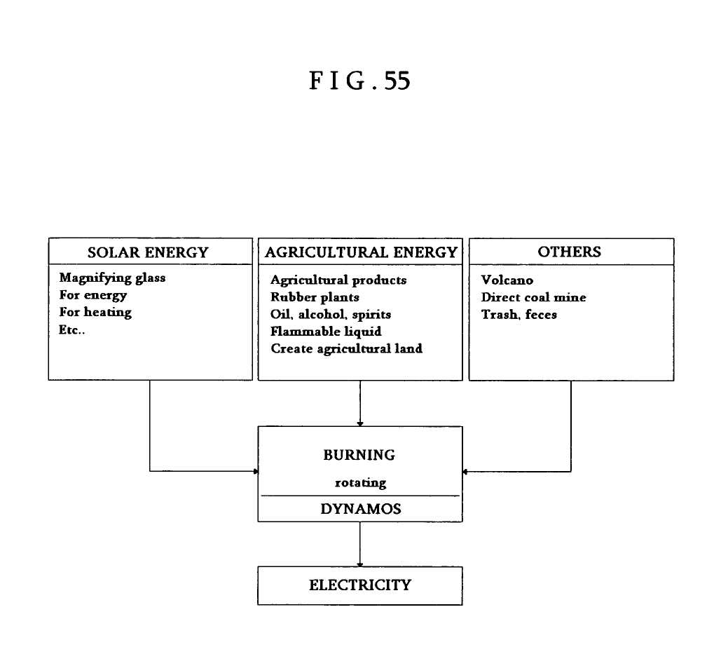

FIG. 56; Energy diagram-3

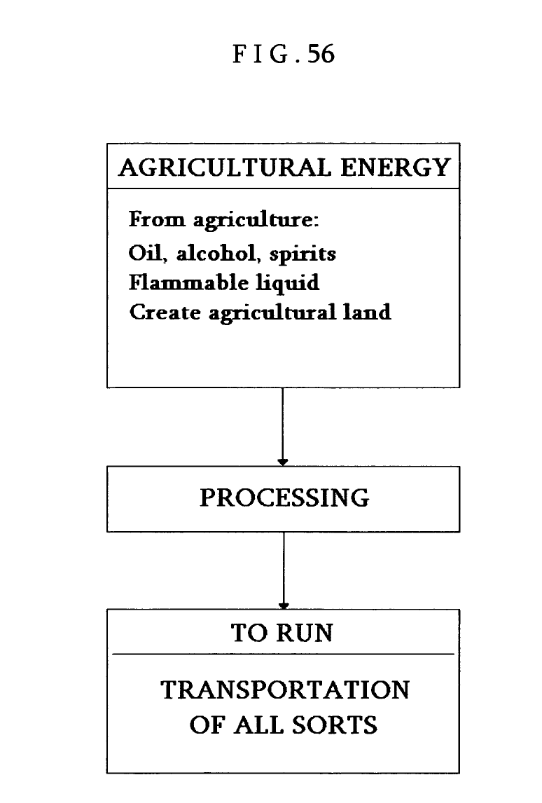

### DETAILED DESCRIPTION OF THE INVENTION

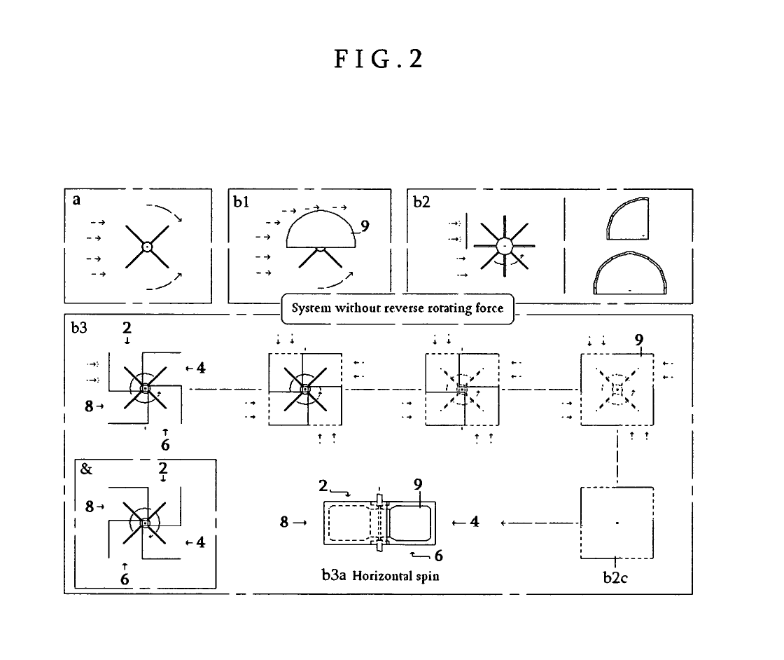

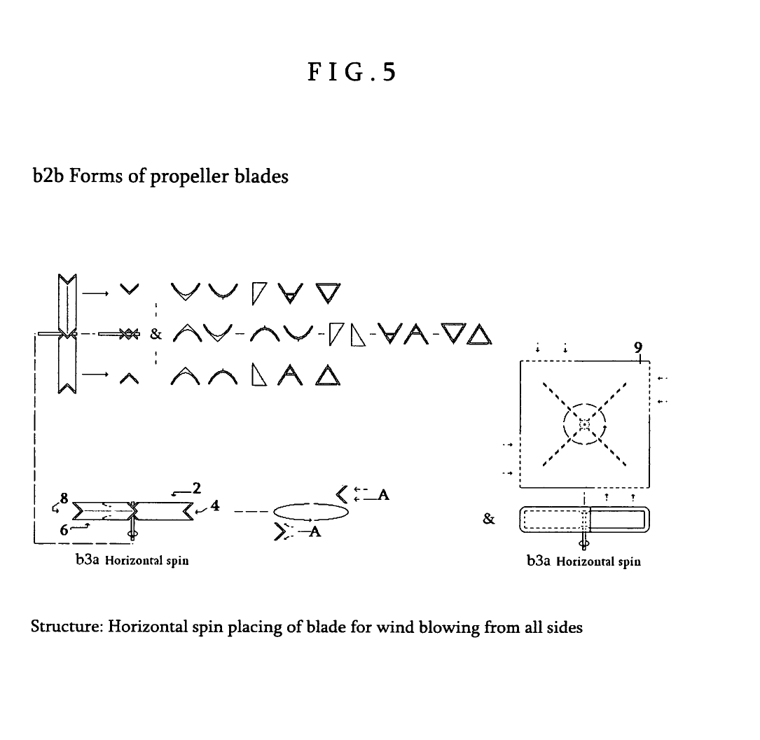

Invention element is to have propeller blade partly covered to concentrate wind blowing at it from sides; 2, 4, 6, 8 of b3; blade 9 turning on FIG. 2, FIG. 5. Partial covered blades should be built in small sizes rather than in large sizes to obtain strong or weak wind force as large blades can not be moved by wind blowing weakly. Multiple partial covered blades of small sizes in a division will evidently gather important wind as a large blade does, further small blades have more advantage to obtain a large scale of wind blowing than a large blade has.

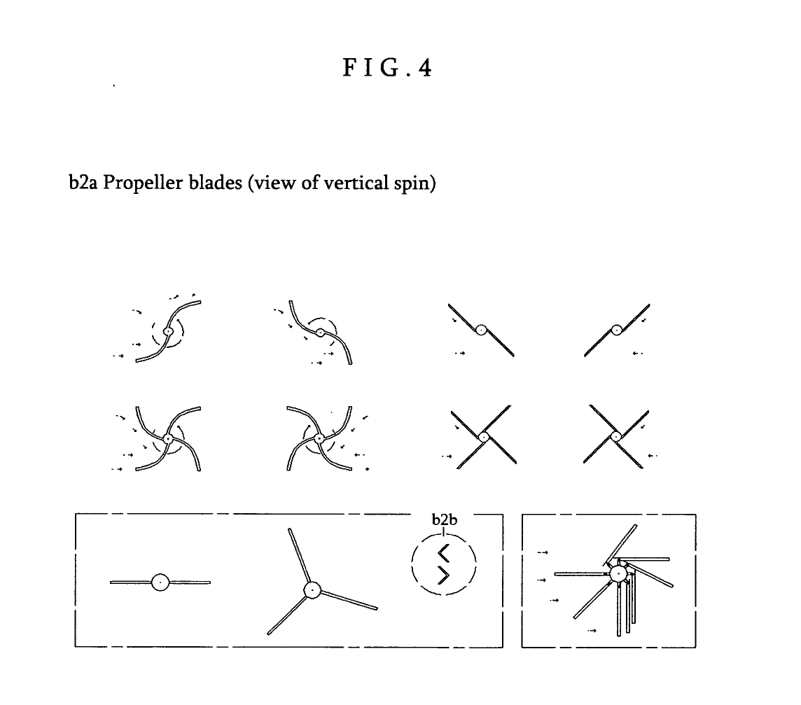

FIG. 5; Propeller blade: b2b forms of blades maintain important element to secure wind rotating dynamos to produce electricity at high speed capacity, if blades are manufactured in one form, spin force equally sustains; this means both rotating and anti-rotating force exist at the time of blades turning. How to decrease anti-rotating force and to increase rotating force of blades blown from same side of wind, my solution is to make blade sharp on one part and flat on other part differently as head of an arrow that its sharp part of blade cuts wind “A” smoothly and its flat part of other blade moves efficiently by wind, propeller blade 9, b2a should be installed rather on horizontal spin b3a than on vertical spin so as to obtain wind blowing from all sides: 2, 4, 6, 8 on FIG. 4, FIG. 5.

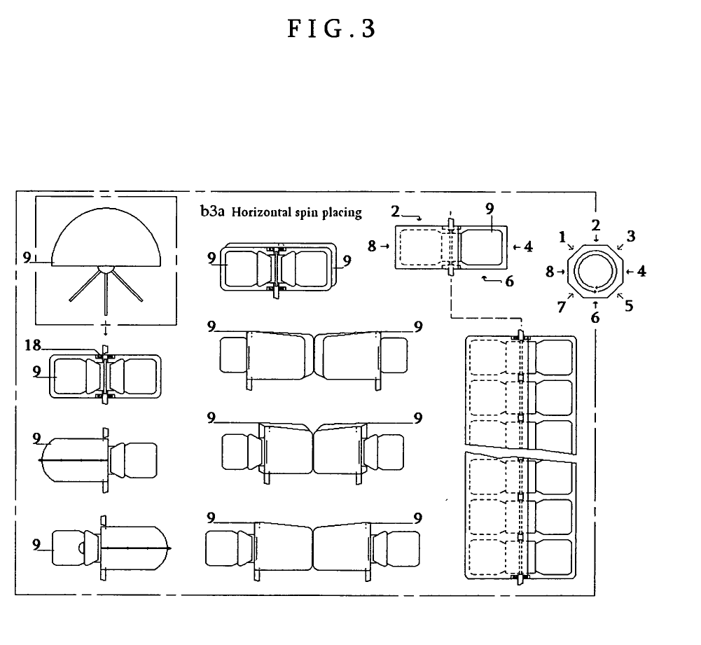

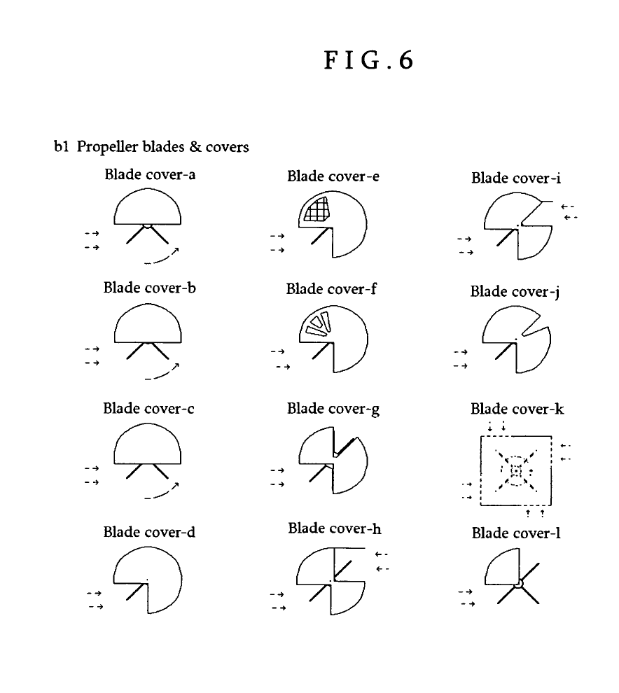

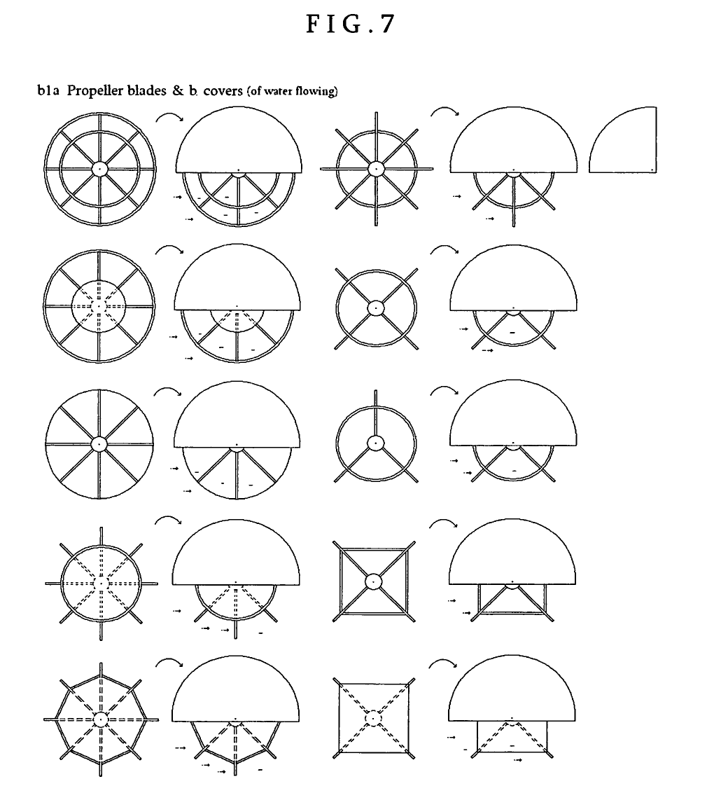

FIG. 3; Half covered blades 9 with bearing 18 should be placed on horizontal spin b3a having wind blown from 1 to 8 sides or be well covered securing wind blowing from sides: 2, 4, 6, 8. FIG. 6; b1 propeller blades with covers of all sorts from type a to type l. FIG. 7; it covers b1a propeller blades and blade covers for water flowing use.

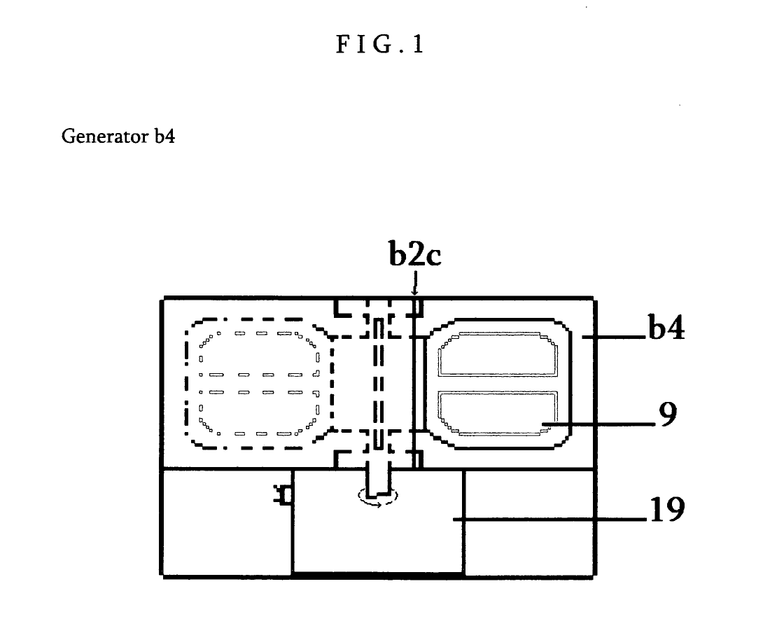

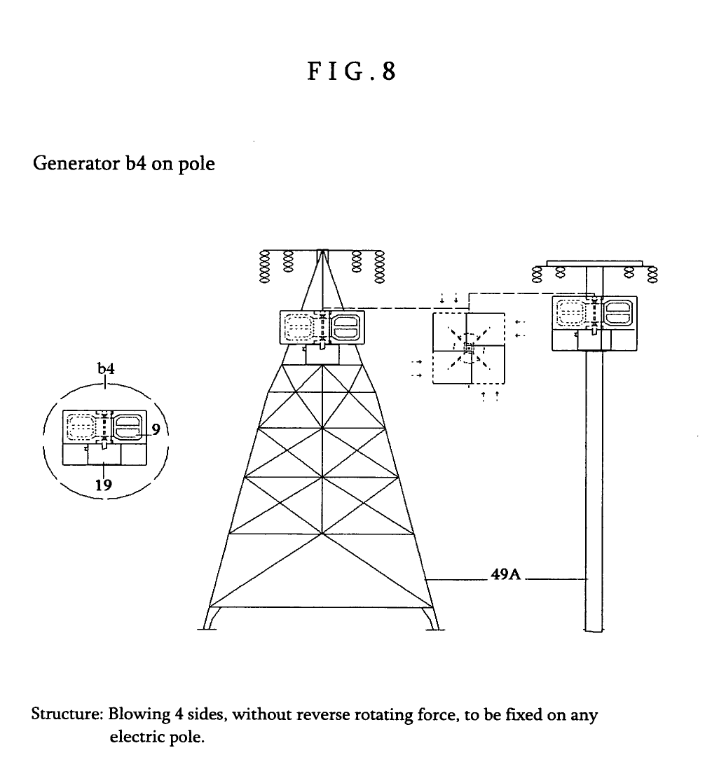

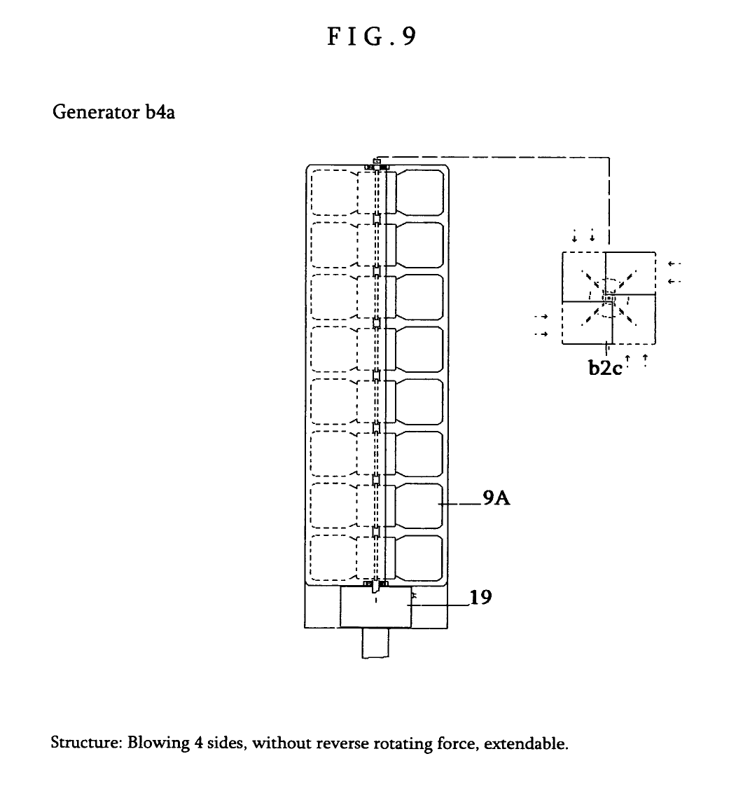

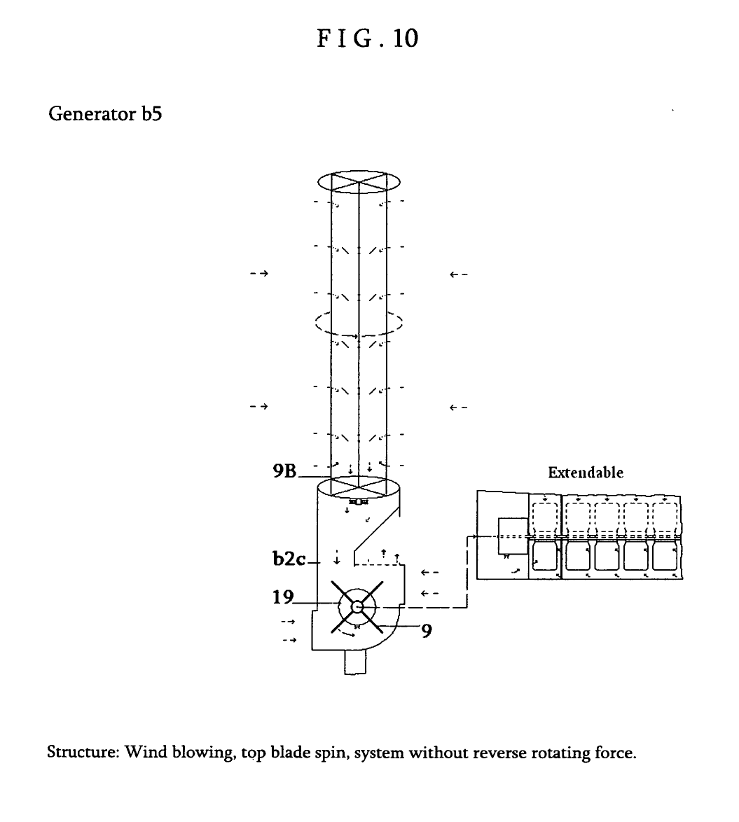

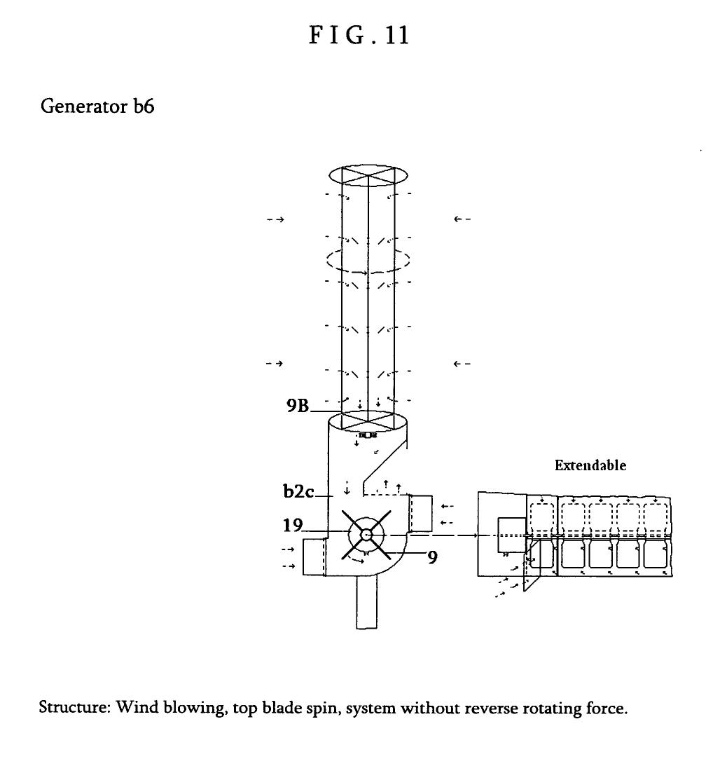

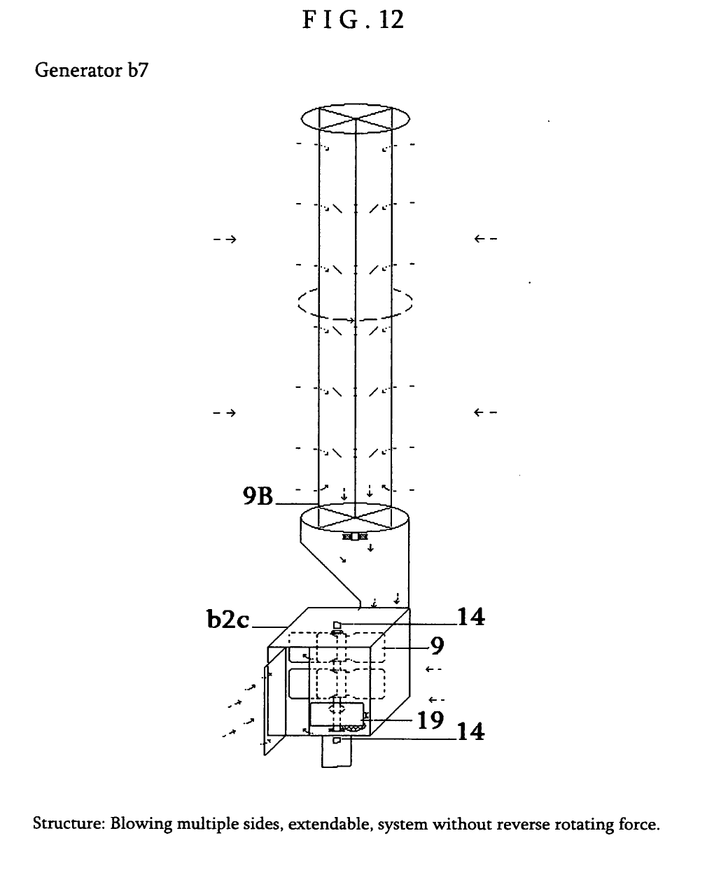

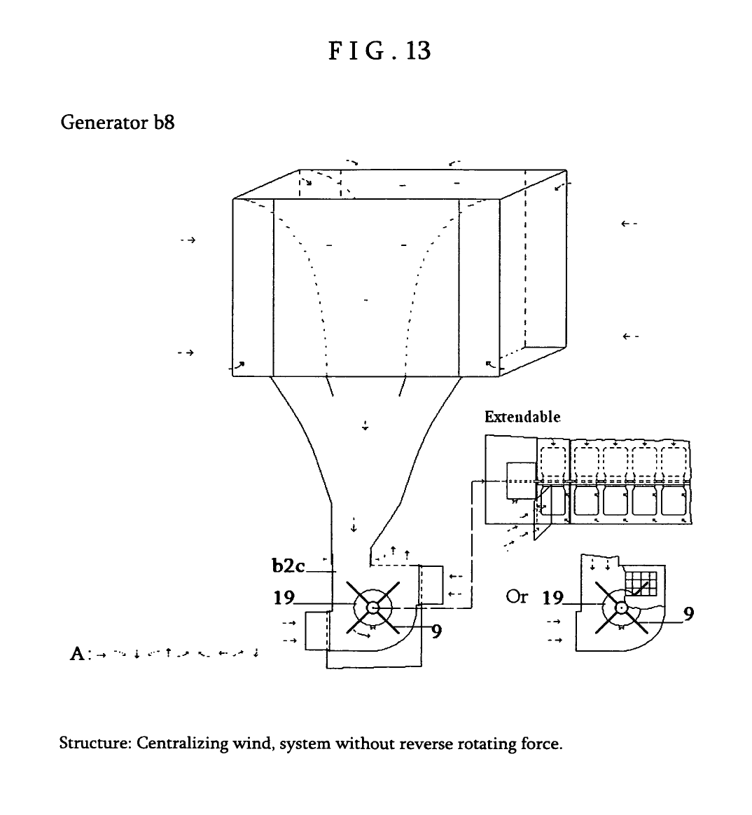

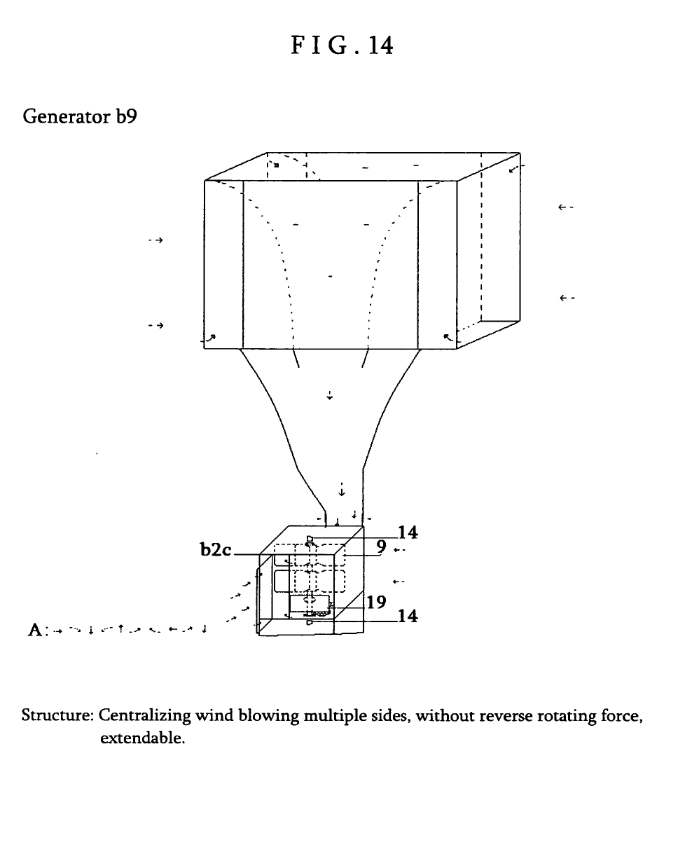

FIG. 1; Generator b4: It has dynamo 19, propeller blade 9 partly covered b2c of system without reverse rotating force, 4 openings letting wind blow from 4 sides to be fixed on any electric pole 49A on FIG. 8. FIG. 9; Generator b4a: It has dynamo 19 linking propeller blade 9A, blade cover b2c, extendable, 4 openings letting wind blow from 4 sides. FIG. 10; Generator b5, FIG. 11; Generator b6, FIG. 12; Generator b7, FIG. 13; Generator b8, FIG. 14; Generator b9: There are dynamos 19, propeller blades 9, blade covers b2c, extendable 14, high top blades 9B spin or large opening letting wind “A” blowing from multiple sides pushing spin, without reverse rotating force.

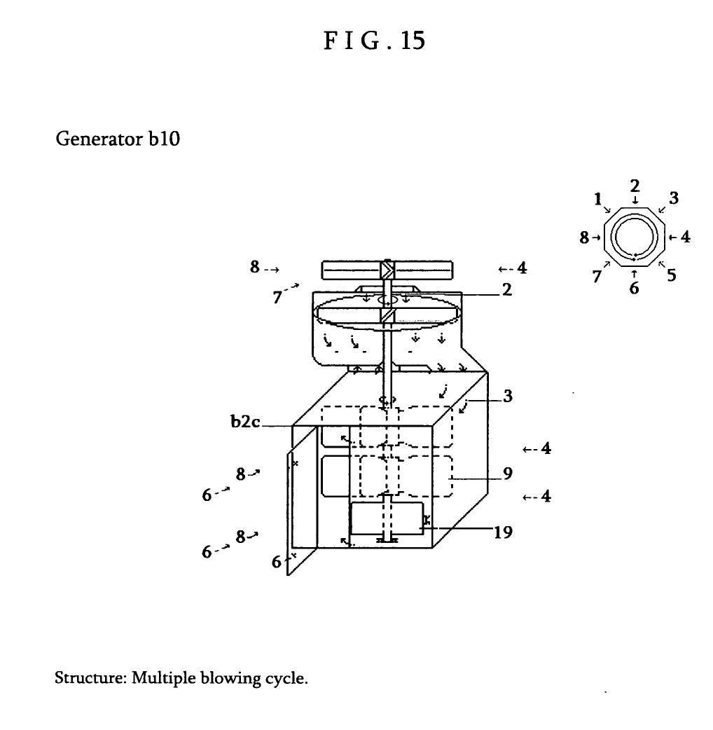

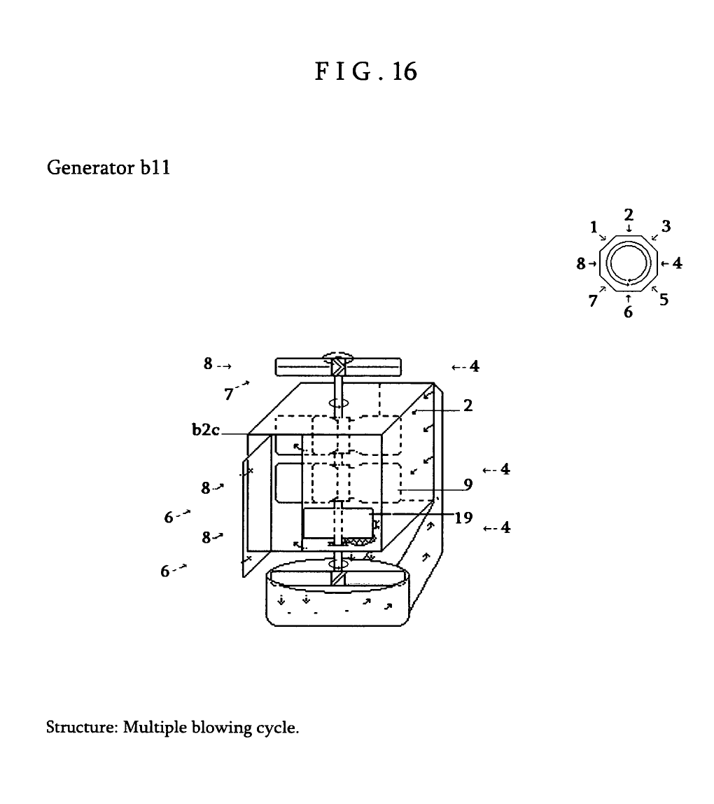

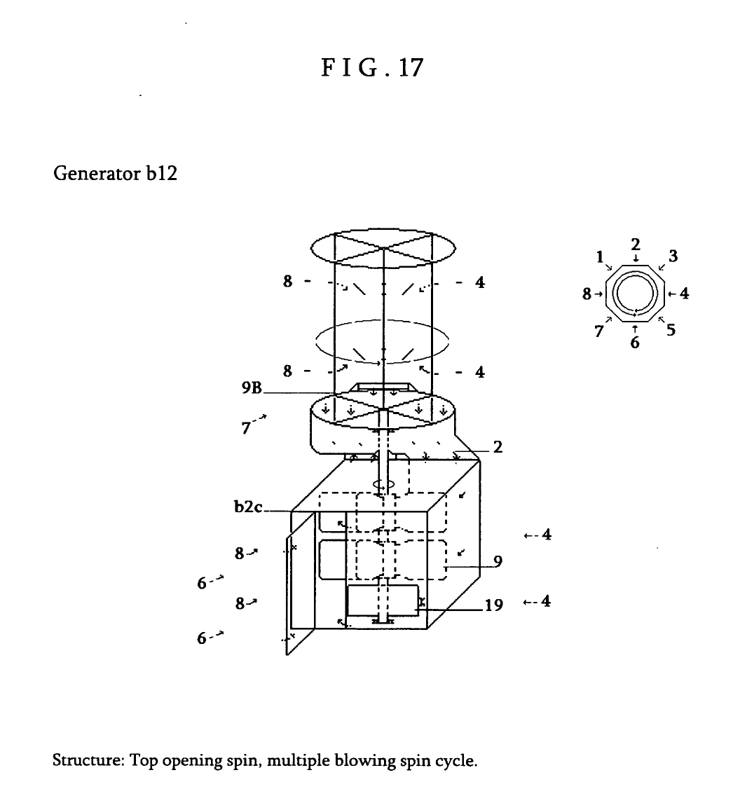

FIG. 15; Generator b10, FIG. 16; Generator b11: There are dynamos 19 propeller blades 9, blade covers b2c, multiple blowing cycle 1-8 shown by arrows, without rotating reverse force of blades. FIG. 17; Generator b12: It has dynamo 19, propeller blade 9, blade 9B spin, blade cover b2c, multiple blowing cycle 1-8 shown by arrows, top opening pushing spin, without reverse rotating force of blades.

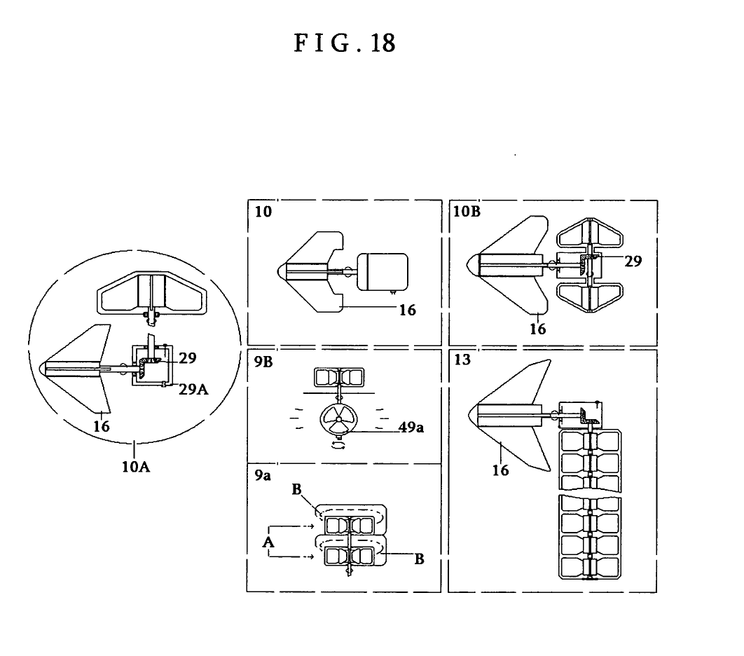

FIG. 18: Propeller blade is equipped in gear 29 oil box 29A with speed acceleration blade 16 of 10A, it will be installed with motor 10 or with two blades 10B, wind A blows directly, wind B reverts blowing blade 9a to accelerate speed, half covered blade turns blade 49a setting on top of house, of cars 9B and half covered blade 13 links.

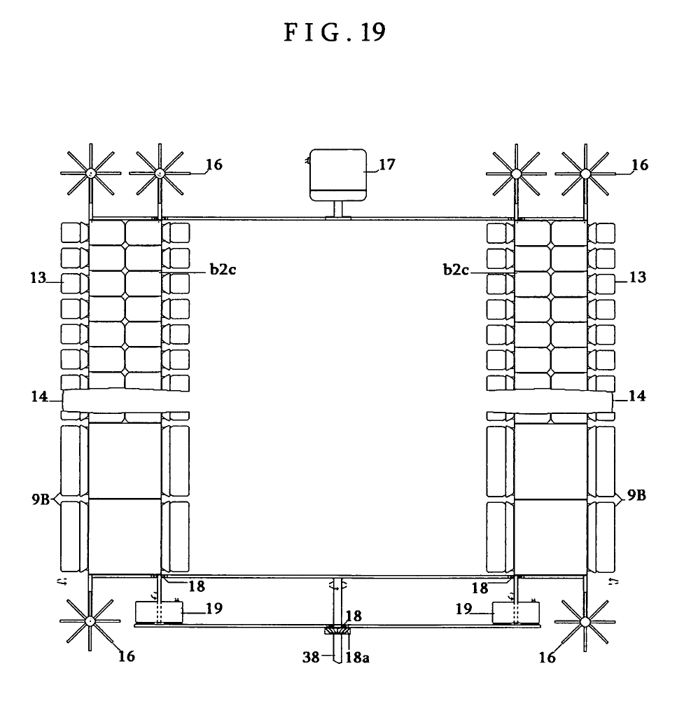

FIG. 19; Generate electricity on circle frame: Quantities of half covered blades 13, 9B with partial covers b2c rotate dynamos 19 via transformers to generate electricity accelerated by speed acceleration blades 16, bearings 18 and 18a on circling frame 38, motor 17 functions timely to keep rotating, cutting extension 14.

Electric power plant in movement: Use moving transportations of all kinds; all vehicles, trains, underground trains, trolleys, automobiles, cars, trucks, buses, vans, engine-vehicles, motor-vehicles, motorcycles, ships, etc to produce electricity on usual utility.

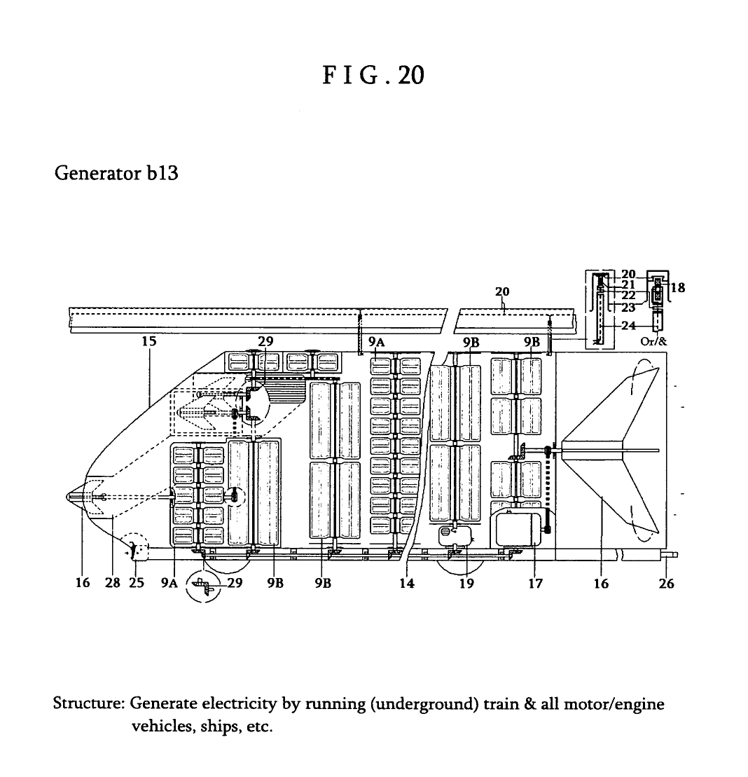

FIG. 20; Generator b13: wind blows half covered blades 9A, 9B to rotate dynamos 19 accelerated speed by accelerating blades 16 in gear links 29 starting by motor 17 or connecting to a train, electric wires 24 are conducted through spring 22, conductor 21 or bearing 18 to electric wire channel 20 in isolating cover 23, air exits through channel 28, connectors 25, 26, train extendable 14 generating electricity on underground train 15 or equivalents.

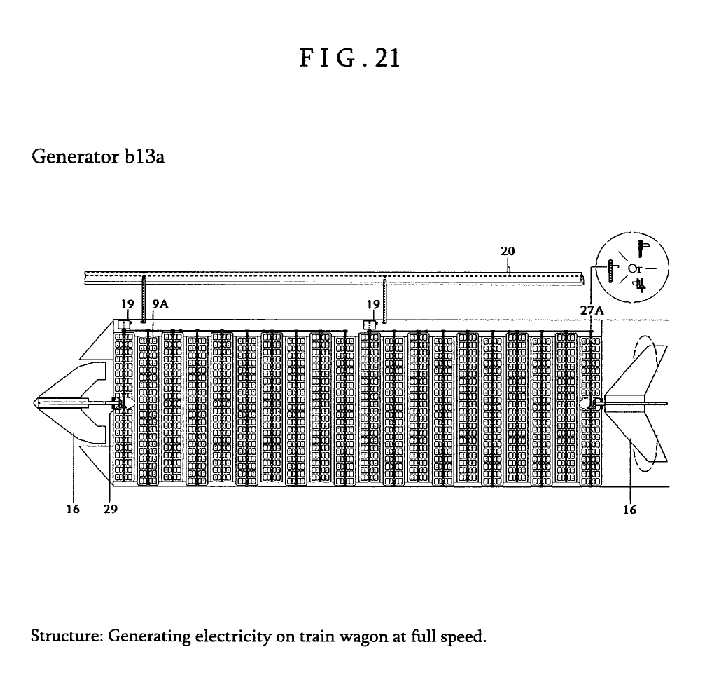

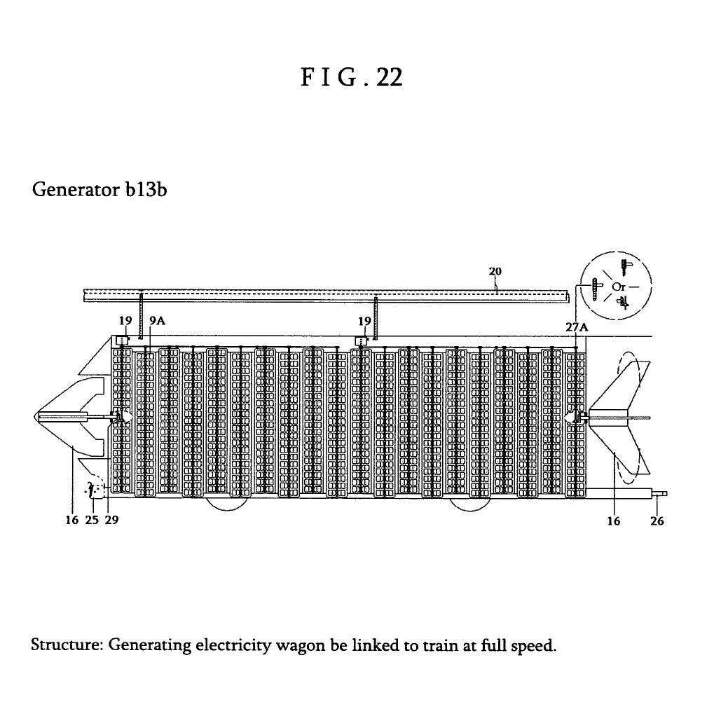

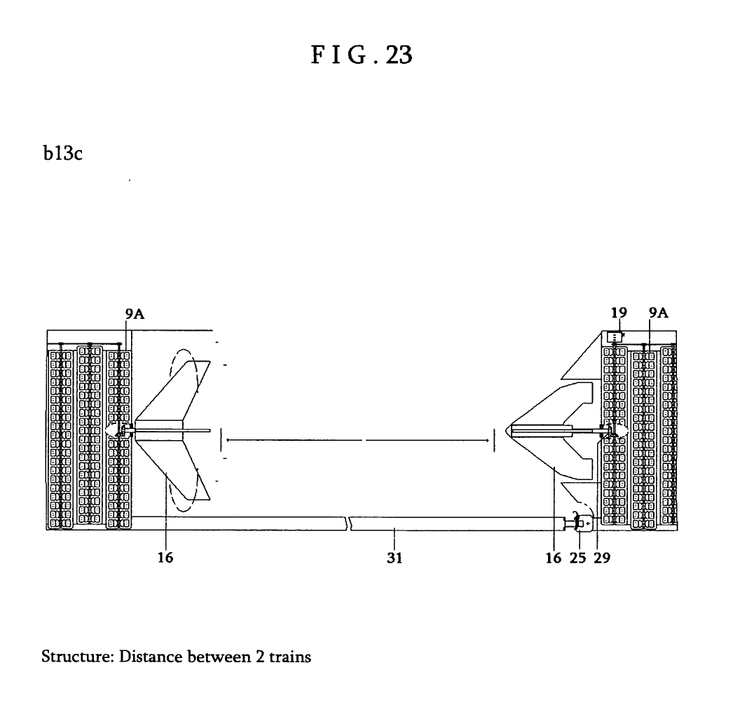

FIG. 21; Generator b13a: Generator wagon is to be installed on train in maximum quantities of propeller blades 9A, blades 16, gear 29, chain 27A links and dynamo 19 to generate electricity onto electric wire channel 20 at high speed. FIG. 22; Generator b13b: Generator train is to be linked to a train one after another by connectors 25, 26 using propeller blades 9A, blades 16, gear 29, chain 27A links and dynamo 19 to accelerate at full speed to generate electricity onto electric channel 20, connector 25 is linked by bar 31 between two trains letting enough space for wind blowing to next trains b13c on FIG. 23.

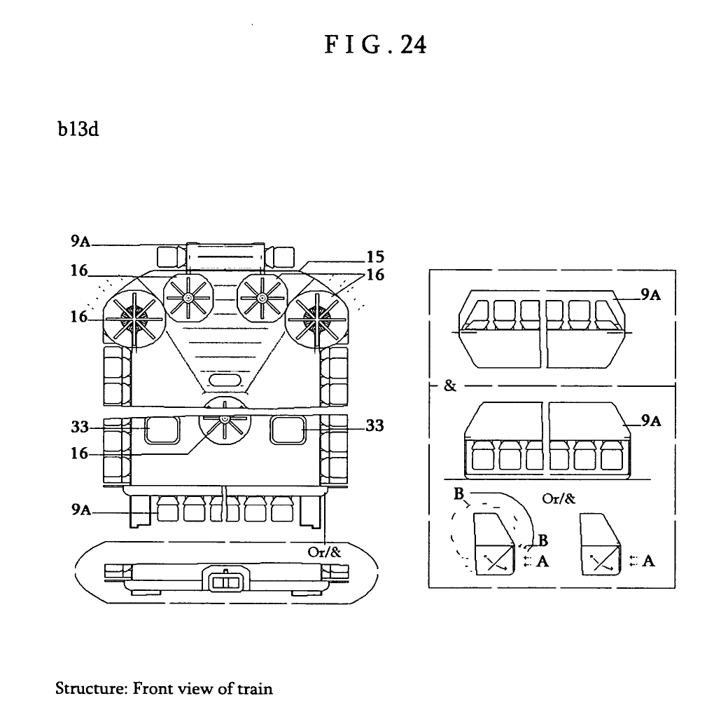

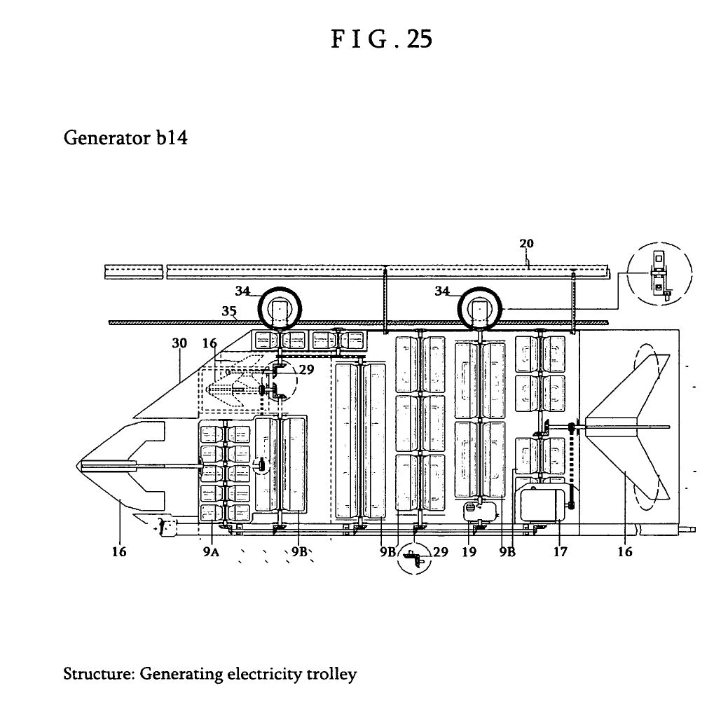

Such moving capacity blows at full speed much more powerful than any other natural wind force, electricity will be transmitted up or down side by electric wires along with train railway to electric current. FIG. 24: b13d shows front view of train 15 having head lamps 33, half covered blades 9A, speed acceleration blades 16 and/or using blades 9A in which wind blows from 2 sides: front A and reverting B. FIG. 25; Generator b14: Wind blows half covered blades 9A, 9B of all sorts, gear 29 to rotate speed acceleration blades 16, dynamo 19 on trolley 30 to generate electricity, rollers 34 roll on cable 35 to hold its frame starting by motor 17, electric wire channel 20 conducts electricity to electric current.

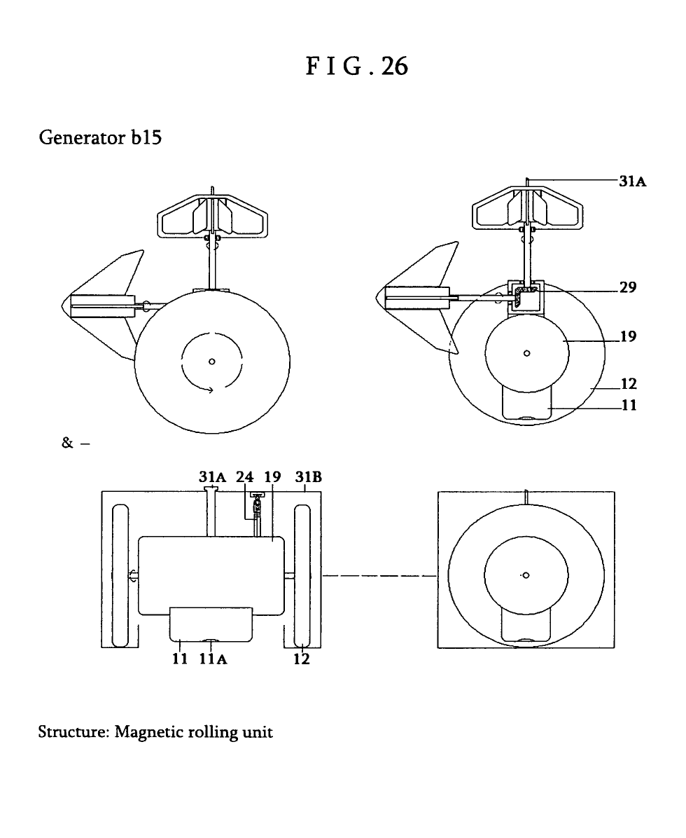

FIG. 26; Generator b15: Magnetic rolling unit: Channel 31B is built on top along with railway, traffic street, bar 31A holds magnetic unit in which magnetic polarized lighting 11A or equivalent technical skill of magnetic box 11 on bearing rollers 12 detecting to chase trains, cars running below, it runs rotating its dynamo 19 to generate electricity by electric wire 24 to electric current through channel, it may be installed gears 29 with blade to accelerate its speed.

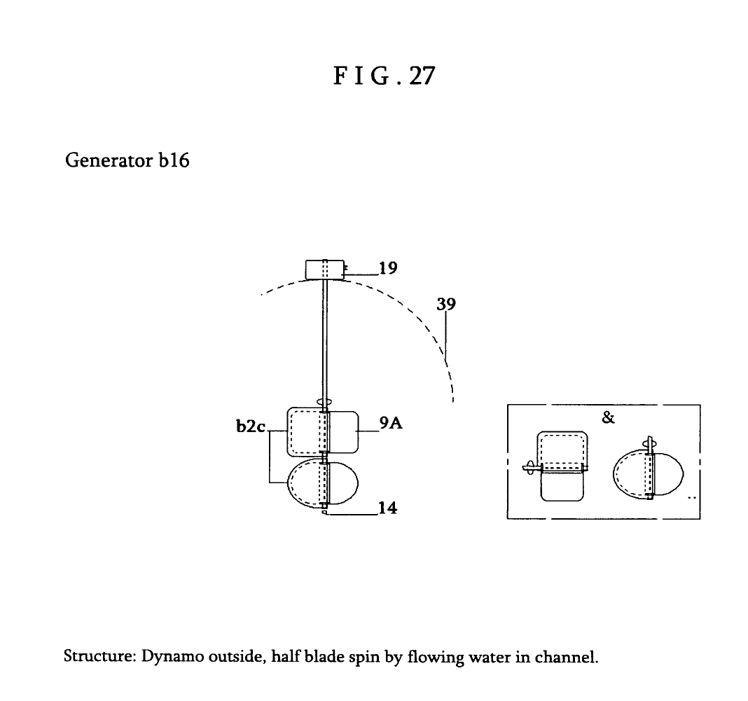

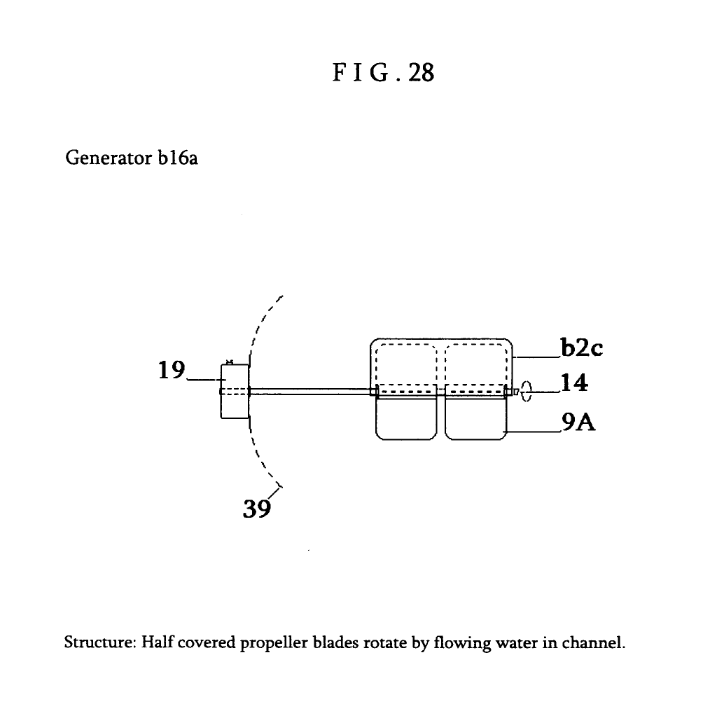

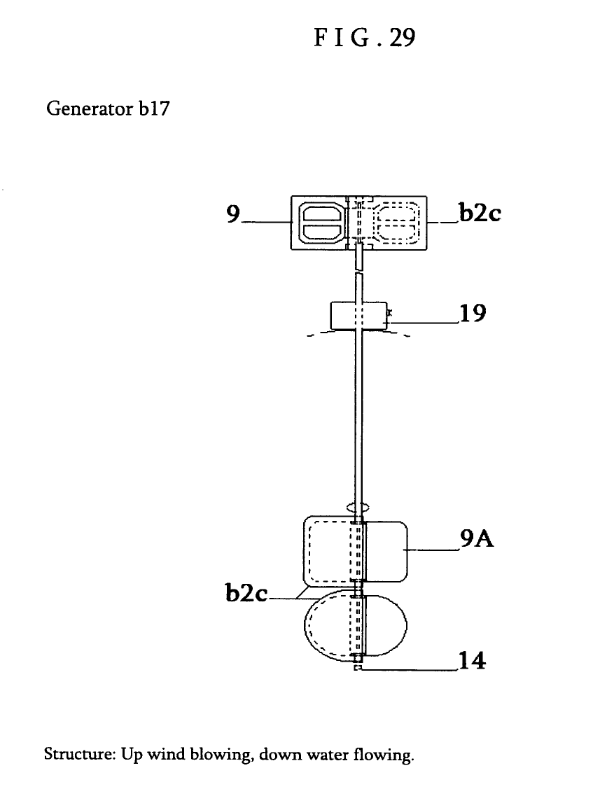

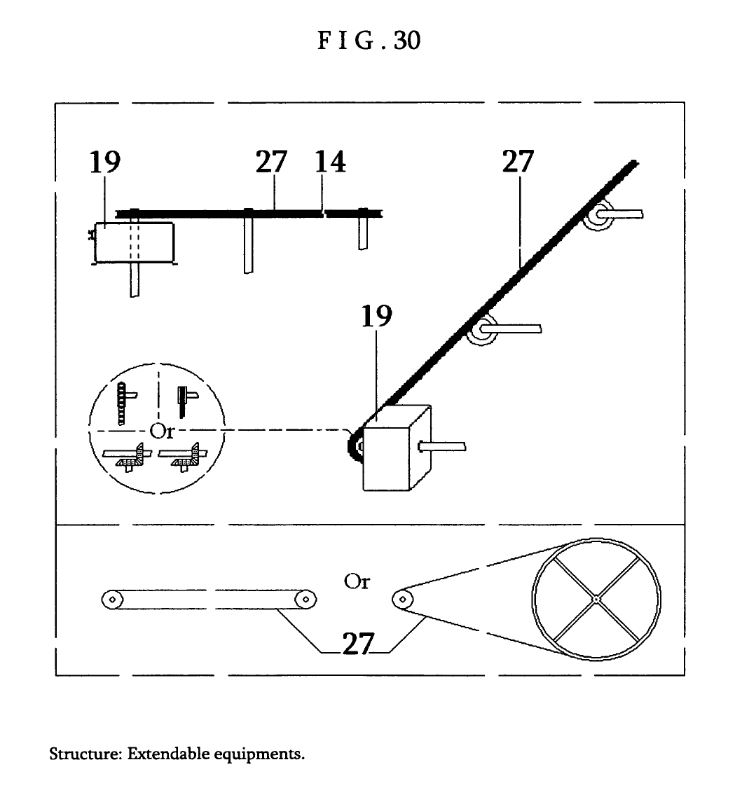

FIG. 27; Generator b16, FIG. 28; Generator b16a: Propeller blades 9A with partial covers b2c rotate dynamos 19 by flowing water inside channel 39, extendable 14. FIG. 29; Generator b17: Propeller blades 9A with partial covers b2c rotate dynamo 19 by flowing water inside channel, by wind blowing blades 9 outside, extendable 14. FIG. 30; Extendable 14 equipments with V. belts 27, dynamo 19.

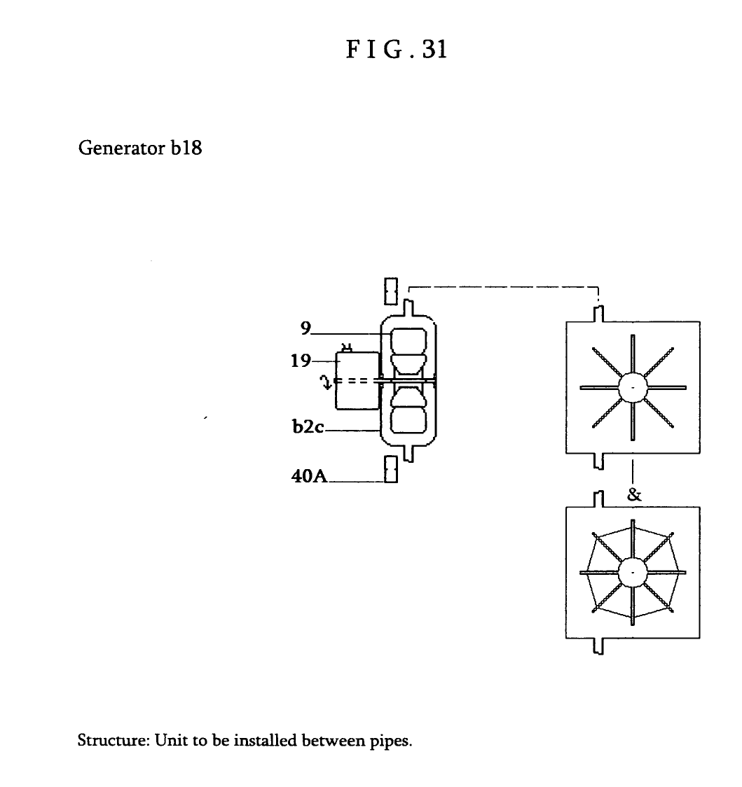

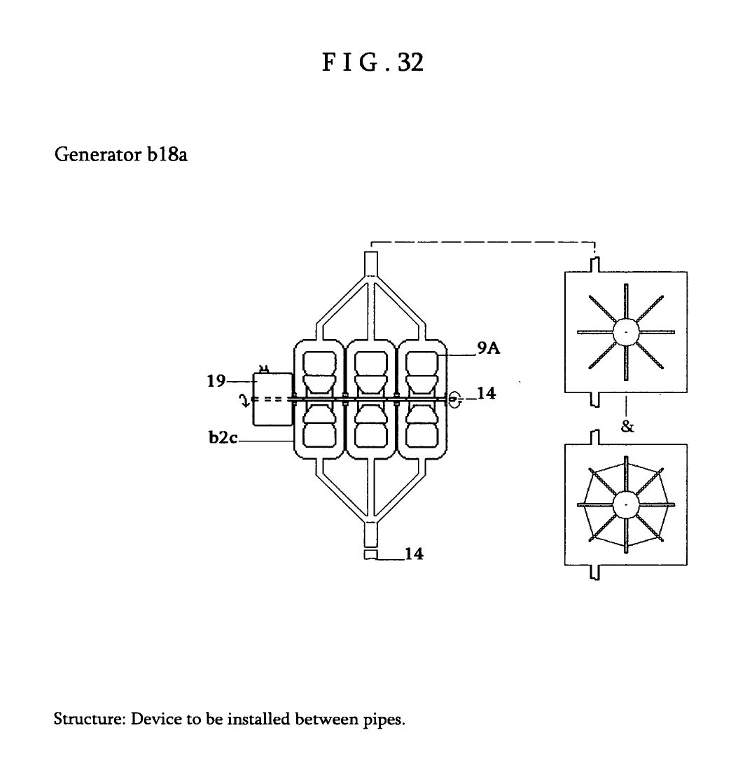

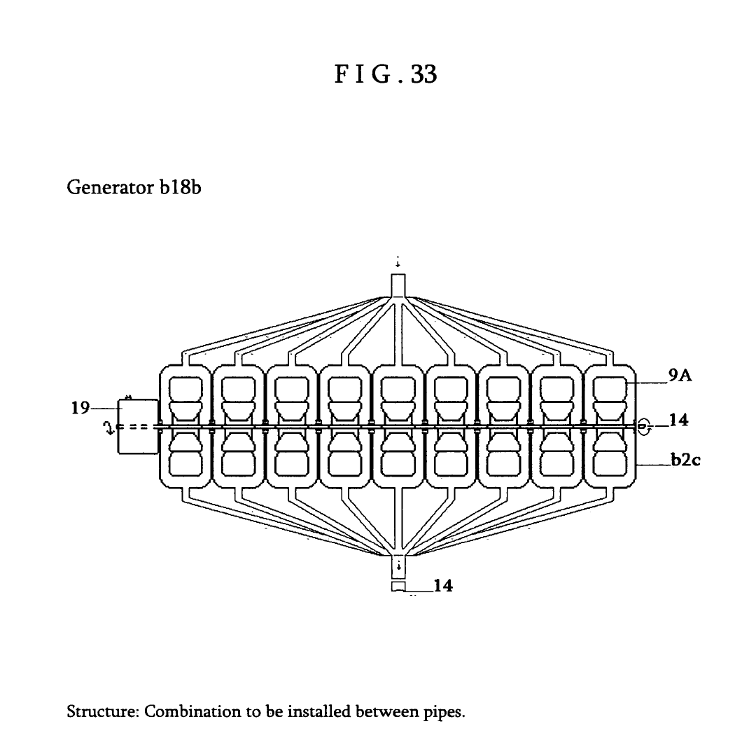

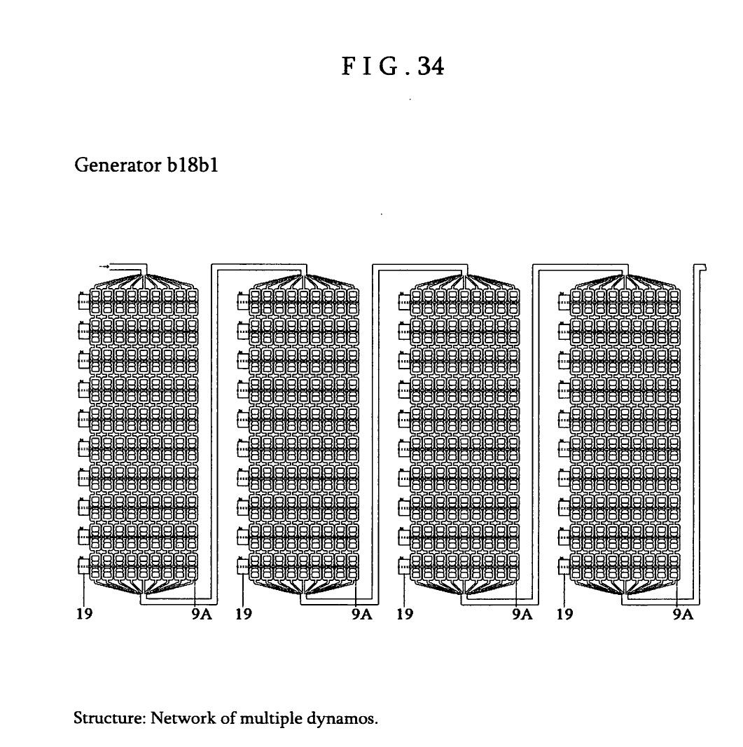

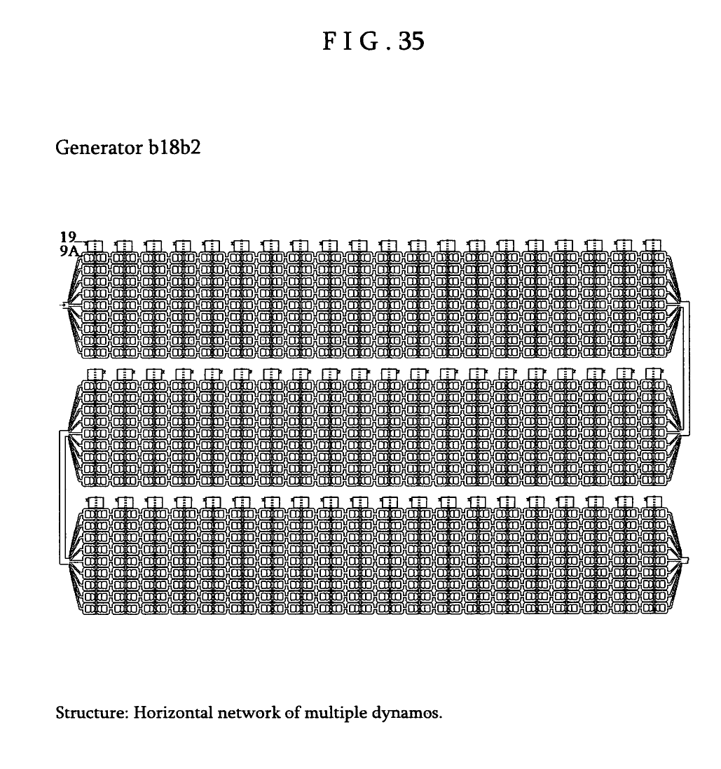

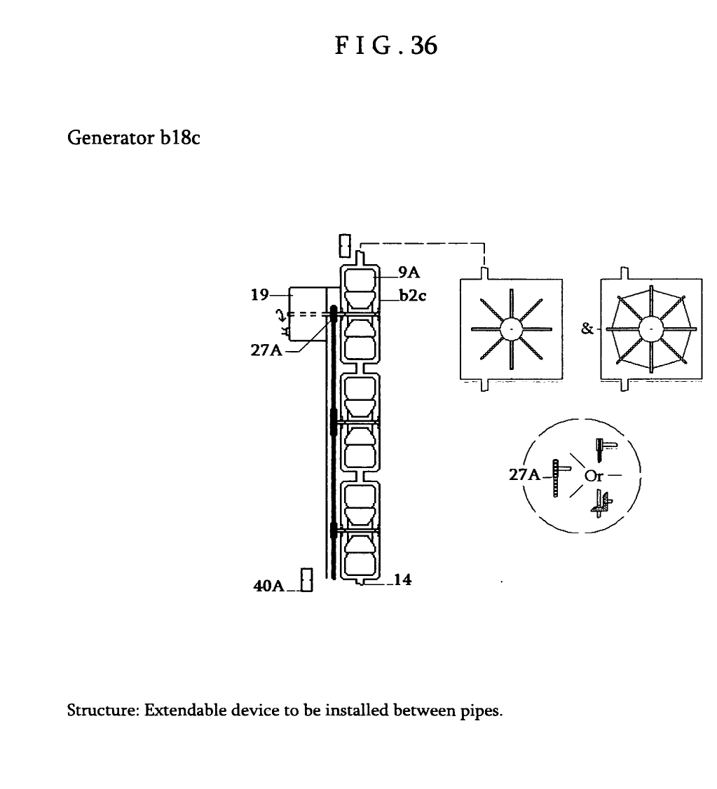

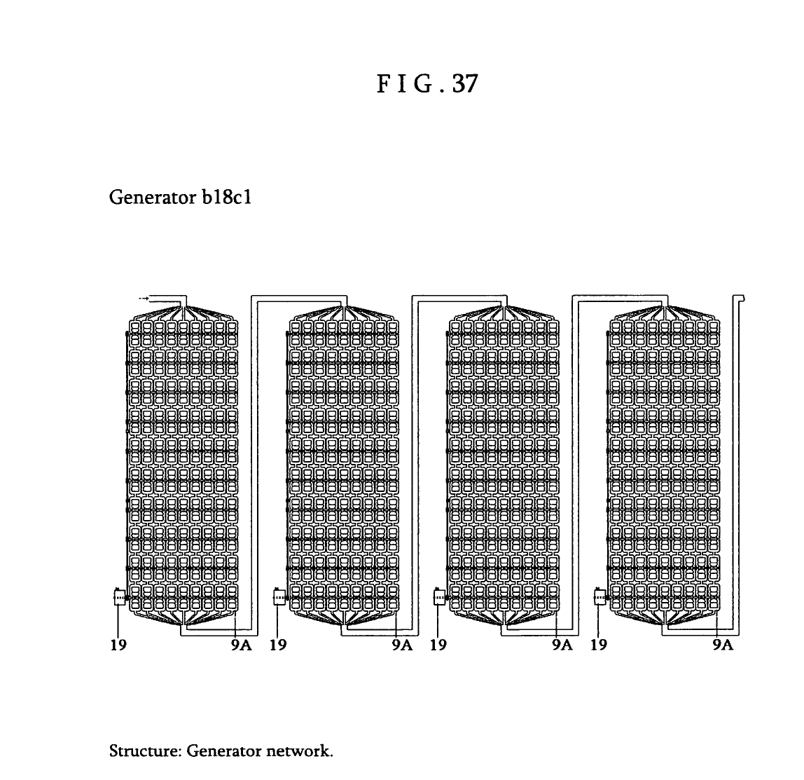

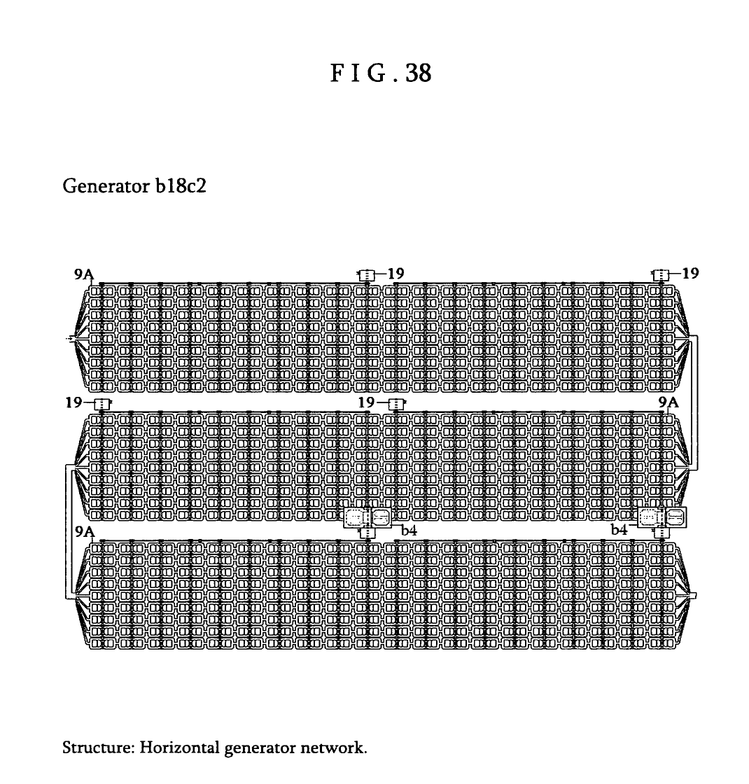

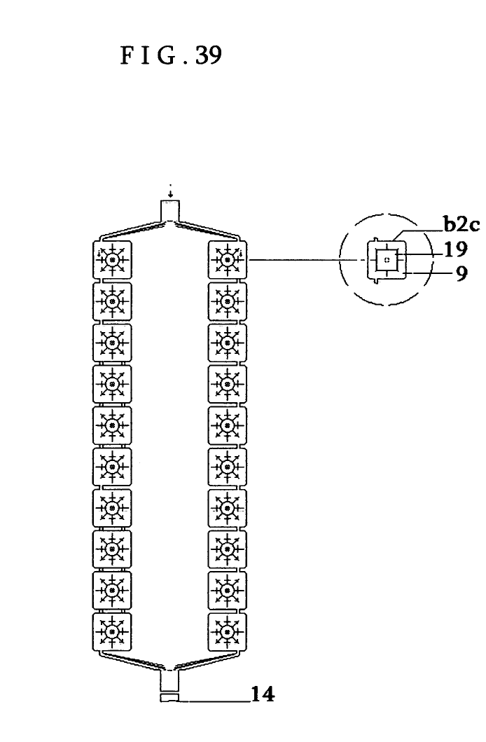

FIG. 31; Generator b18, FIG. 32; Generator b18a, FIG. 33; Generator b18b: Propeller blades 9, 9A with covers b2c rotate dynamos 19 by flowing water to be connected between pipes, connectors 40A, extendable 14. FIG. 34; Generator b18b1, FIG. 35; Generator b18b2: Combination blades 9A rotate multiple dynamos 19 by passing of water. FIG. 36; Generator b18c: Propeller blades 9A with covers b2c rotate dynamo 19 by flowing water connecting V. belt or chain 27A to blades, connectors 40A, extendable 14. FIG. 37; Generator b18c1, FIG. 38; Generator b18c2: Combination blades 9A rotate dynamos 19 and b4 in flowing water network. FIG. 39; View of generator b18b-1, blades 9 with covers b2c, dynamos 19, extendable 14.

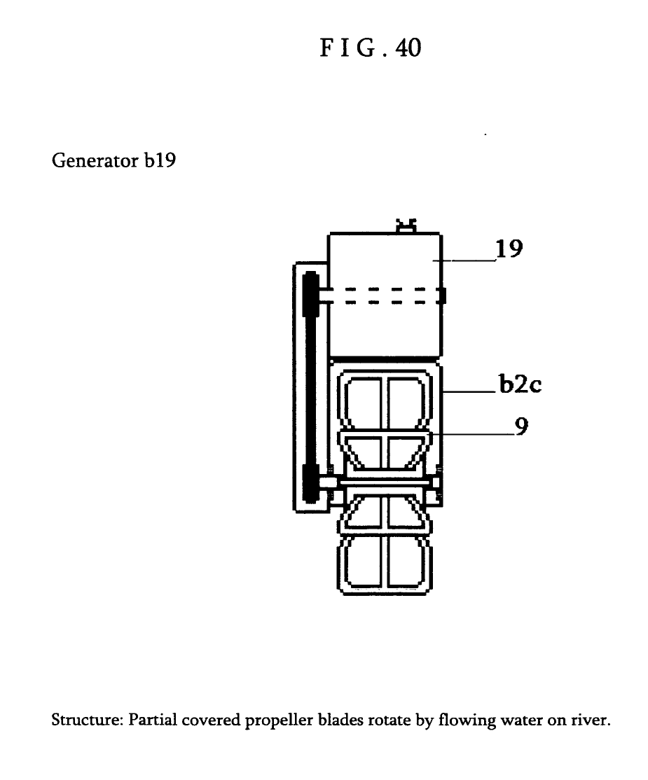

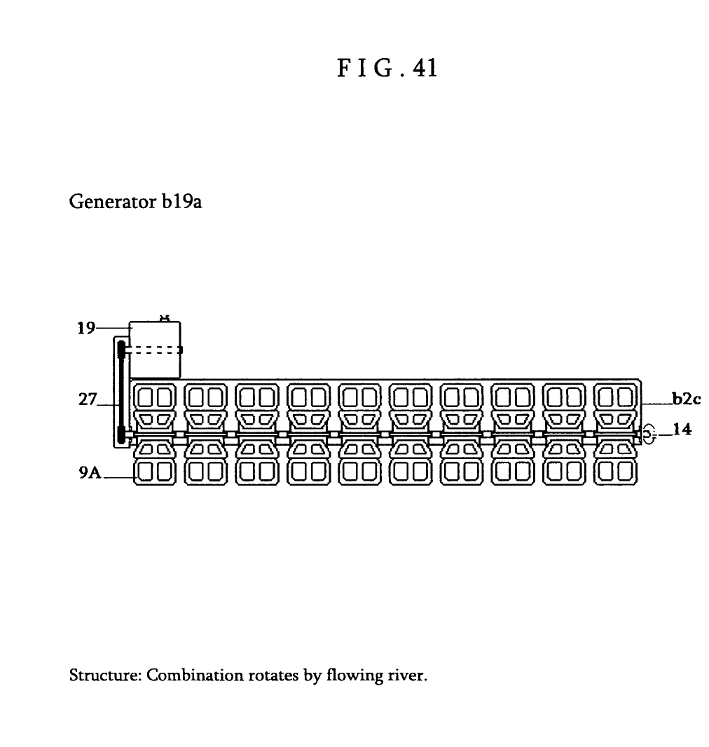

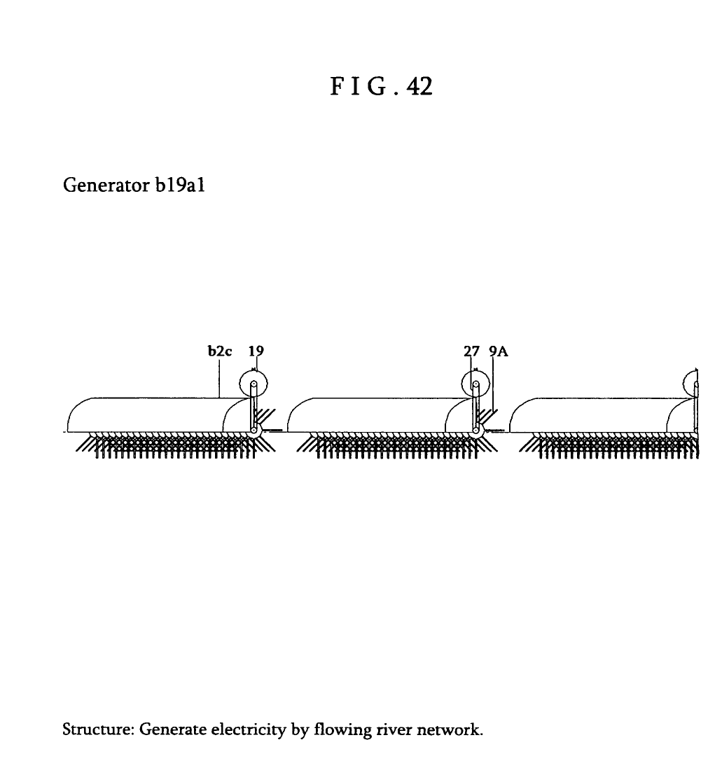

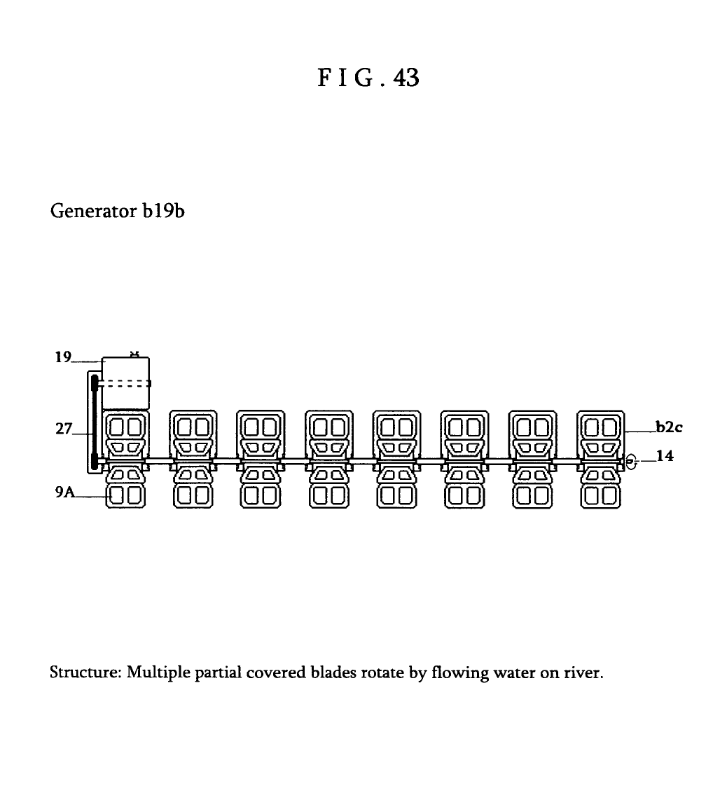

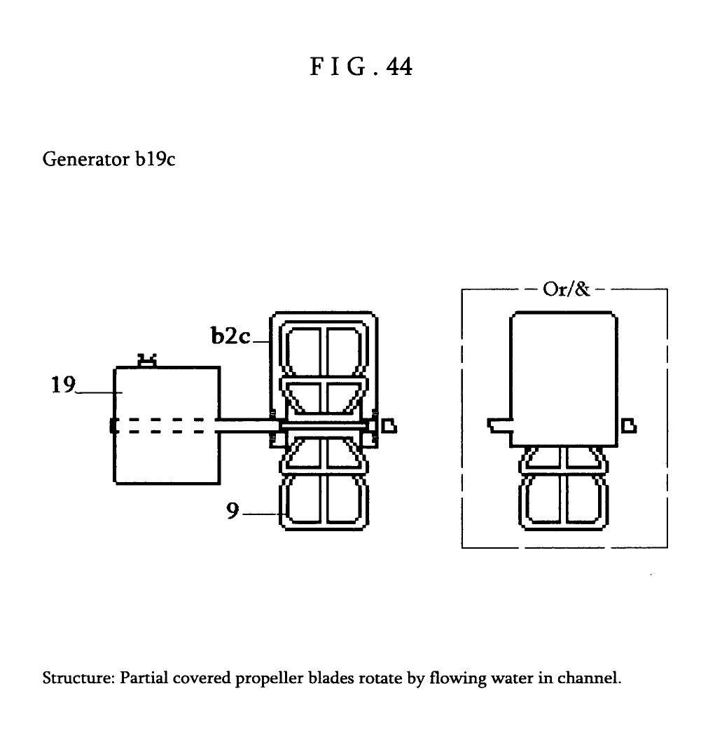

FIG. 40; Generator b19: Partial covered b2c propeller blade 9 rotates dynamo 19 by V. belt on flowing river. FIG. 41; Generator b19a: Combination blades 9A with partial cover b2c rotate dynamo 19 by V. belt 27 on flowing river, extendable 14. FIG. 42; View of generator b19a1: Combination blades 9A with partial cover b2c rotate dynamos 19, V. belts 27 on flowing river network. FIG. 43; Generator b19b: Propeller blades 9A with partial covers b2c rotate a dynamo 19 using V-belt 27 by flowing water on river, extendable 14. FIG. 44; Generator b19c with blade 9, partial covers b2c, dynamo 19 rotating by flowing water in channel.

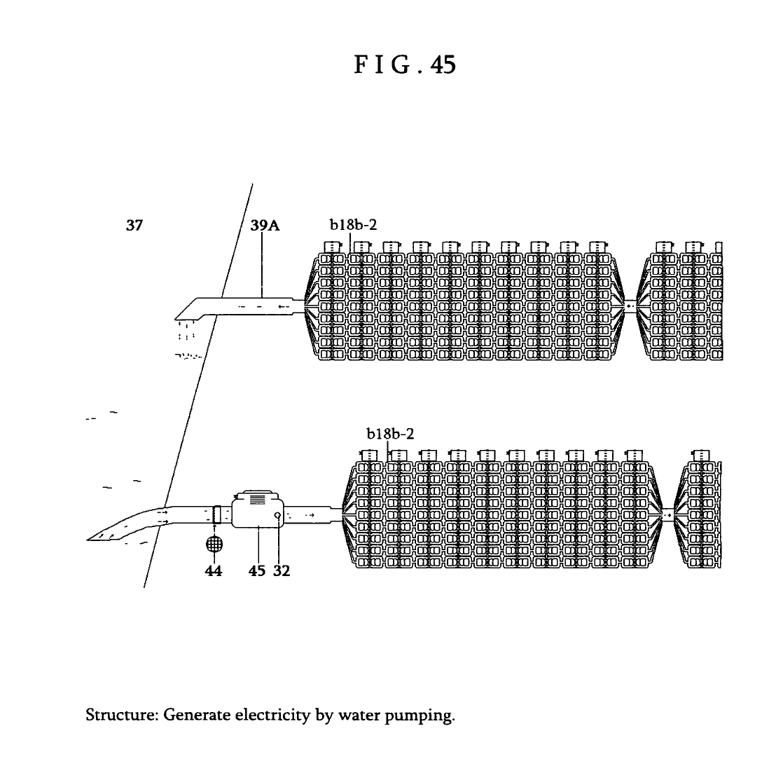

FIG. 45; Generating electricity under water pumping: Water pump 45 pumps water through filter 44 flowing to generator b18b-2 from ocean, sea 37, lake, etc generating electricity, water pump functions timely or reacts by (engine type) thermostat 32, water flows back through pipe 39A to the sea.

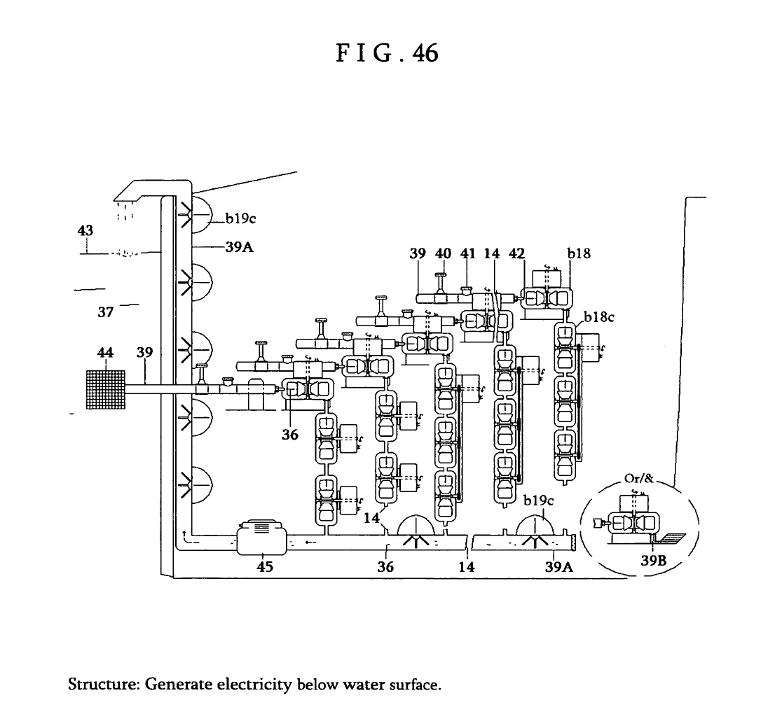

FIG. 46; Generating electricity by water, liquid, air pressure and/or equivalents: Using water pressure generates electricity to be done at or below surface level 43 of ocean, sea 37, lake, river, pool, water containers, etc. We dig room at sea border and insert pipes 39 or equivalents to water side, filters 44 are fixed at head parts of pipes, water 36 flows in spraying 42 blades of generator b18 and b18c to generate electricity, pipes have valves 40 and control boxes 41. Pump 45 pumps water through pipe 39A into the sea or sewer 39B, generators b19c are built along pipe, system is extendable 14.

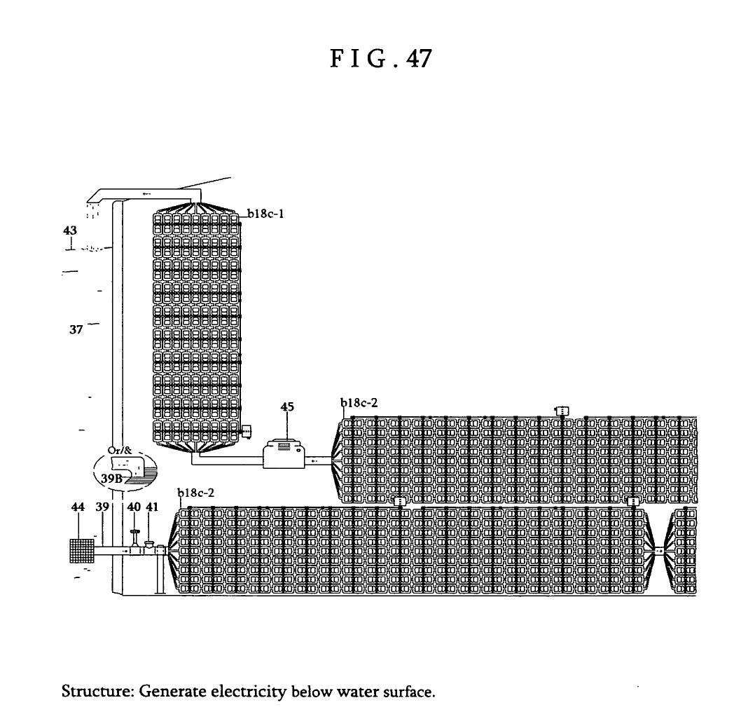

FIG. 47; Generating electricity below water surface level 43 of ocean, sea 37, lake, river, pool, water containers, etc: We insert pipes 39 to water side at sea border, filter 44 is fixed at head part of pipe, it has valve 40, control box 41, water flows through generators b18c-2 and b18c-1 to generate electricity. Pump 45 pumps water through pipe into the sea or sewer 39B.

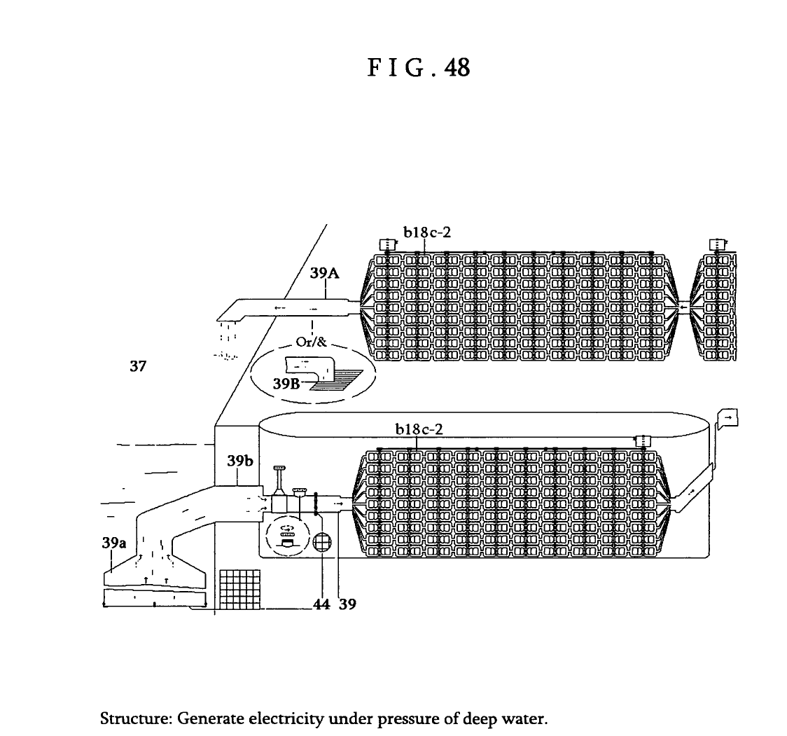

FIG. 48; Generating electricity by deep water pressure: We insert pipe 39a in the sea 37, its top part 39b is connected another pipe with filter 44 below water surface at sea border, water from deep pressure rushes to top into smaller pipe 39 through generator b18c-2 to generate electricity on the ground one after another, water flows through channel 39A back to the sea or to sewers 39B.

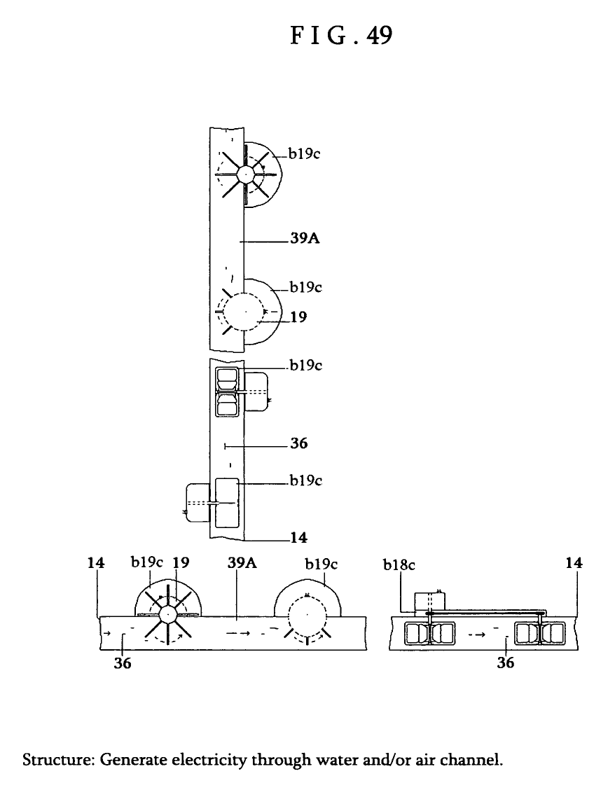

FIG. 49; Generating electricity through liquid channel: Passing of water 36 rotates generators b18c, b19c with dynamos 19 to generate electricity in water or liquid pipes 39A of all sorts, line 14 shows length extension. Another proposal is to install half covered blades to rotate dynamos and/or equivalents in water flowing channels of both water supply incoming and used water outgoing network inside and/or outside houses, buildings etc in entire country via transformers to generate electricity at no cost.

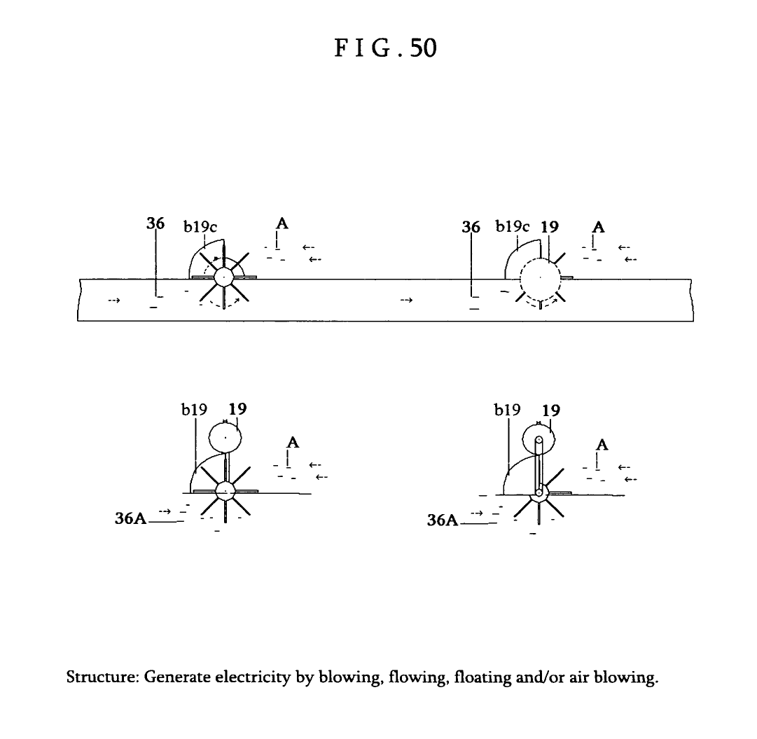

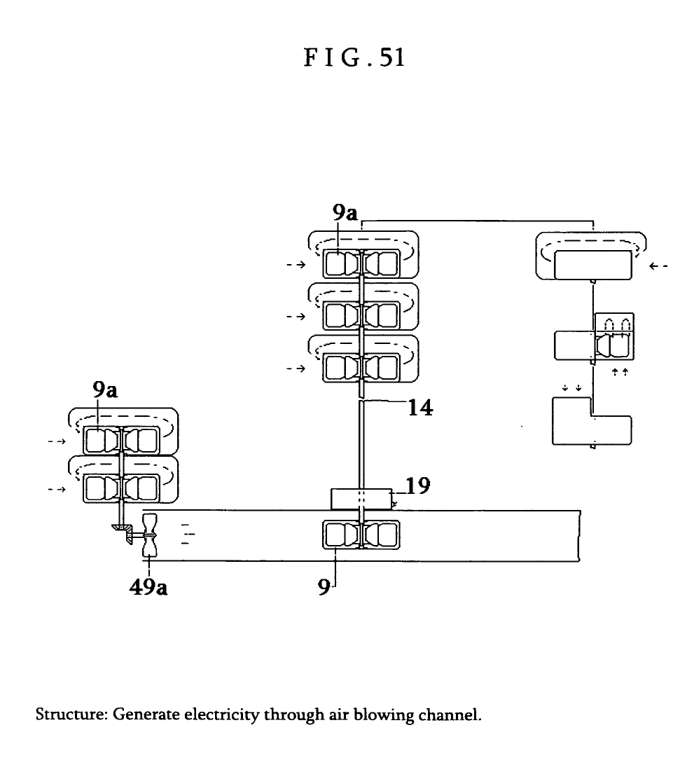

FIG. 50; Partial covered blades blowing at two sides: Passing of water 36 rotates generator b19c with dynamo 19 to generate electricity in water or liquid pipes, wind A blows from opposite side to speed up its spin, blade rotates generator b19, dynamo 19 on flowing river 36A. FIG. 51; Generating electricity through air blowing pipe: Half covered blades 9a rotate blade 49a to blow other blades 9 generating electricity by dynamo 19 through pipe, extendable 14.

Solar burning energy: It does not produce energy powerful enough by direct solar shining but focus of its heating on a point will create an energy even to make something burning. What my research took place on this point.

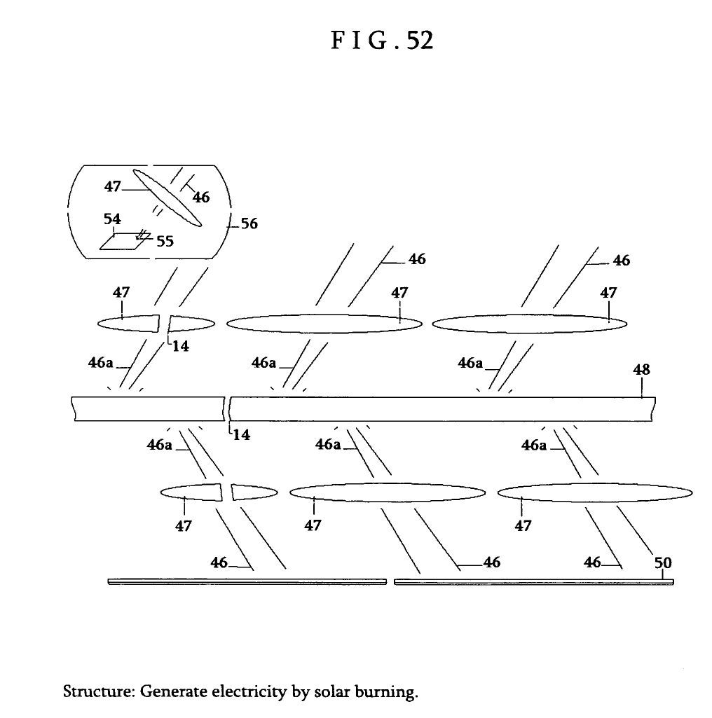

FIG. 52; Electricity by solar burning: If you take a magnifying glass 47 under solar heating 46 on a sheet of paper 54 during a few minutes, this paper is on fire 55 on 56. If a paper is replaced by a piece of metal 48 as below picture, it will eternally be heated up by focusing heat 46a under magnifying glass 47 through sun shining 46, its energy spreads 14 along length of the metal as coals burning to generate electricity, another heat concentration is reflected by mirror 50.

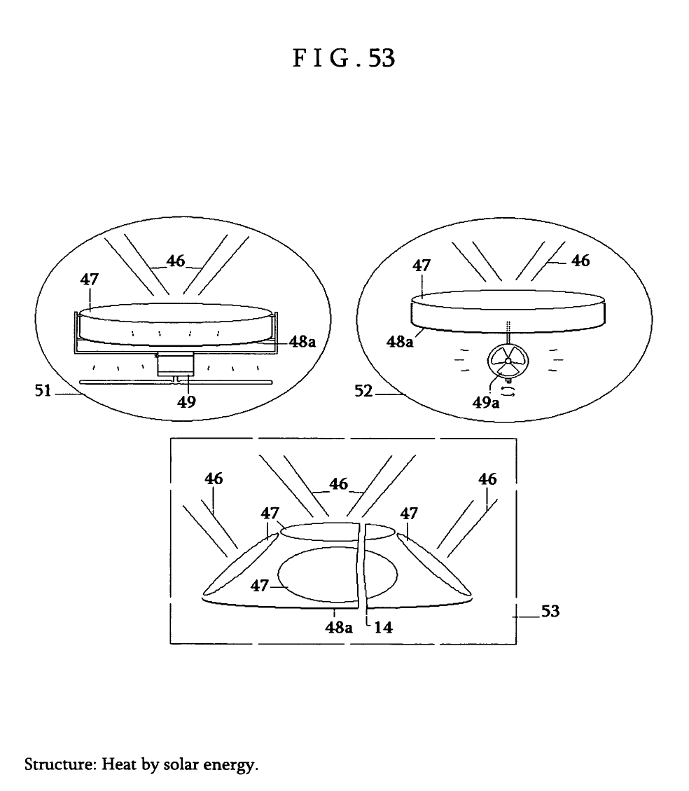

FIG. 53; Heat by solar energy: Sun 46 shines through magnifying glass 47 on a metal 48a and blade 49 or 49a is installed to spread heating to warm up a room on FIGS. 51, 52, 53 which show multiple magnifying glasses 47 to heat large space on extension 14.

Flammable liquid: Alcohol, spirits, firewater, liquor, and/or equivalent products with or without refined process are used replacing gasoline in my discovery to run transportation of all kinds and are used in place of petroleum burning to produce electricity, alcohol is made from grain or molasses costing less, cutting freight, producing locally in most countries.

Flammable liquid: Oil of all sorts from agricultural products; Oil can be used, refined, processed more flammable replacing gasoline in my discovery to run transportation of all kinds and oil, rubber plants of all sorts are well used burning to produce electricity.

It expends billions of dollars on petroleum to produce electricity around the world per year, agricultural products are produced in a restricted limit against over production, my discovery is to use agricultural products of over production burning to produce electricity saving a budget of billion dollars and their sediment be used as fertilizer for agriculture. As huge quantities of toxic chemicals are utilized to poison inserts to protect farming harvest, these toxic chemicals are absorbed as fertilizer by plants so such harvest will be harmful to human beings. My discovery is to replace such chemical by hot pepper powder, liquid or any other similar equivalents to blind eyes of inserts to injure them keeping away from farming harvest harmless to all of us.

Burning trash to produce electricity: Trash will a sort of material be useful burning to produce electricity that further billion dollars can be saved for energy bill, quantities are huge by population producing considerable energy for free. Anti-air pollution is to build chimney highest enough in burning plant letting smoke disappear towards the sky after burning.

Coal mine: Burning coal directly from coal mine to produce electricity in my discovery is to reduce developing charges averting danger of miners, electric power (rolling) station should be built nearby to cut freight, it is imaginable somewhat as certain small active volcano openings. But if underground gas or similar air has risk to explore during burning, it should use up gas on the spot before burning process. Moreover, active volcano: Use burning of active volcano in my discovery to generate electricity for free.

Expanding land to use soil, sands, sediment (burnt from agricultural products), etc to fill coast enlarging territories: Move land, mountains from states of icy weather as Alaska in the north to enlarge territories of southern states as California, Florida, where climates are warm, where lands cost valuable advantage to produce energy, flammable liquid from agricultural products to generate electricity and to run transportation of all kinds, as New York, Hong Kong, etc where lands make more housing for inhabitants. Furthermore, remove upper parts of highlands in the north where cold weather will turn to be warmer on plain favorable for agriculture that their removing soil be used for enlarging territories towards southern coast to obtain agricultural energy grown up on earth.

What I claim as my invention is:

1-3. (canceled)

4. Half and/or partly covered propeller blades being equipped rotating dynamos/generators by wind, by moving transportation, by flowing of liquid and energy by sun burning, by volcano, by products by energy plants from agricultural land for generating electricity being connected using for housing, industry, etc, including:
half and/or partly covered propeller blades; propeller blades of all forms being half covered, partly covered and/or hidden blades (out of blowing wind), center axis of which linked with dynamos/generators letting wind blowing at opening blades without causing rotating reverse force of propeller blades fixing on any electric poles as desirable, generators of b4, b4a with 4 openings or more,
propeller blade of all forms with/without partial cover being made either ordinary form or sharp form as arrow head driving wind smoothly and flat at its opposite blades moving efficiently by wind, numbers of blades to center axis made as desirable, propeller blades of all forms with/without partial cover placing horizontally for obtaining wind blown from all sides, except traditional propeller blades placed vertically rotating with reverse spin force of propeller blades to generate electricity,
structure by wind, air blowing, water flowing; half covered blades with dynamo(s) equipping between pipes, upper certain opening parts blown by wind and lower opening blades positioning inside pipes either blowing by air or flowing by liquid without causing reverse rotating force for generating electricity, center axis of upper parts be linked with that of other half covered blades blown by wind at opening blades,
speed acceleration blade(s); propeller blade being placed vertically, its center head point of axis against wind, each blade from center alas made as dart form, its sharp point in front, larger part at rear drilling wind forwarding, numbers of blades to center axis made as desirable, side of blades made either ordinary form or sharp form as arrow head driving wind smoothly, in which equipping with motor, with half covered propeller blade(s) blown by wind, with combination of half covered blades blown by wind, etc. half covered blade blown by wind turning rotating blade(s), half covered blade blown dry by wind and indirectly reverting wind to blades for accelerating speed,
half covered propeller blades with dynamos/equivalent generators b16, b16a of installing inside flowing water channels, generator b17 with 4 opening propeller blade unit(s), generators b18, b18a, b18b connecting between pipes in unit/combining units, generators b19, b19a, b19a1, b19b flowing by water/rivers, generators b5 to b9 of high top blade spin or large opening for wind pushing spin, generators b10 to b12 of 4 opening propeller blade unit(s) & with arrow head form blade(s), extension by V, belts, pulley, etc,
generating electricity on circling frame; wind blowing half covered propeller blades to rotate dynamos/equivalents for generating electricity accelerated by installed speed acceleration propeller blades starting timely by motor,
structure for moving transportation, generators b13, b13a, b13b of generating electricity on train, underground train, train wagon and/or equivalents, moving transportation of all kinds; all motor/engine vehicles, trolleys, automobiles, cars, trucks, buses, vans, ships, motorcycles etc using for honing, industry, etc; wind blow half covered blades equipped at both sides to rotate speed acceleration blades at center, dynamos/generators for generating electricity, starting by installed moor on underground train or connecting to a train, electricity transmitting by electric wires along with railway up or down side to electric current, connection using electric wire through spring conductor or bearing to wire channel in isolating cover,
structure of running train b13c, b13d; each running train unit being separated each other at suitable distance letting space for wind blowing to next trains linking by bar between two trains, installing half covered blades, speed acceleration blades at both sides and gathering both direct and reverting wind blowing at blades of head train,
structure of moving transportation b14; wind blowing half covered blades equipped at both sides to rotate speed acceleration blades at center, dynamos/generators for generating electricity on erg trolley rolling on cable to hold its frame starting by installed motor, electric wire channel conducting electricity to electric current,
structure of magnetic moving force; magnetic rolling unit installing in channel on top along railway, traffic street, its magnetic polarized lighting or equivalent technical skill on bearing rollers detecting to chase trains, cars running below, its dynamo of generator b15 rotating for generating electricity, accelerating blades be added to accelerate speed,
structure by water pump; pump installed pumping water from ocean, sea, river, lake, or pool, etc through filters flowing to pipes in which half covered propeller blades of generators b18b-1, b18b-2 equipped between pipes for generating electricity, war pump functioning timely or reacting by thermostat to keep water flowing and back to the ocean, sea, river, lake, or pool, etc,
structure below surface of water level b18c-1, b18c-2; we digging room at border of ocean, sea, river, lake, pool, etc or any other similar operations either below or on the surface of water level and inserting pipes with filers to water side, water flowing in spraying half covered propeller blades of generators b18, b18c, b19c equipped between pipes along for generating electricity, pipes having valves and control boxes, pump(s) installed pumping water through pipes into the ocean, sea, river, lake, pool, etc or sewer,
structure of deep water pressure; we inserting larger pipers) in the ocean, sea, river, lake, or pool, etc, its top pan connecting another pipe(s) with filter(s) either below or on the surface of water level at sea border, water rushing from deep pressure to top into smaller pipe(s) through installed half covered propeller blades of generators b18c-1, b18c-2 one after another on the ground for generating electricity, water flowing back through pipes to the ocean, sea, river, lake, pool, etc or sewers,
structure by flowing of water; passing of water rotating opening blades of half covered propeller blades of generators b18c, b19c equipped between pipes along water/liquid channels where pipes of all sorts in water flowing of both water supply incoming and used water outgoing network inside and outside houses, buildings, etc and equipped floating on flowing rivers or equivalents in entire country for generating electricity,
energy by sun burning & solar heating; sun shining under installed magnifying glass both focusing heat and reflecting by mirror upon length of metal as coals burning for producing electricity and solar shining through magnifying focusing on metal using fan(s) spreading heating to whole room, combining more magnifying glasses concentrating heating on large space, beam of lamp/bulb focusing through magnifying glass upon metal or equivalent formation reproducing energy for saving electricity,
energy by products, by trash; agricultural products of over production, flammable liquid from agriculture, rubber plants of all sorts burnt for producing electricity for free and their sediment using as fertilizer, of which using hot pepper powder, liquid or any other similar equivalents in my discovery replacing toxic chemical to blind eyes of inserts injuring them for protecting farming harvest harmless to human beings and energy by trash; trash, feces used burning for producing electricity for free, building chimney highest enough in burning plant letting smoke disappear towards the sky after burning,
energy by direct coal mine and active volcano burning coal directly from coal mine as active volcano craters for producing electricity reducing charges, transportation freight, averting danger of miners in which using up underground gas if any averting risky explosion, and using burning of active volcano as energy for generating electricity for free,
energy by expansion of land; moving land, mountains, removing upper parts of highlands from states to states and using their soil, sand, sediment, etc to fill coast for enlarging agricultural territories of warm climate for producing agricultural energy, flammable liquid for generating electricity, for running transportation of all kinds, for making lands more housing for inhabitants.

5. Alcohol, firewater, oil of all sort from agricultural products burning for generating electricity and using as energy for running transportation of all kinds; all vehicles, engine-vehicles, motor-vehicles, automobiles, cars, trucks, buses, vans, trains, underground trains, trolleys, motorcycle s, aircraft, helicopters, space rockets, ships, submarines, fleet, moving objects of all sorts, including:
flammable liquid; using alcohol, spirits, firewater, liquor, oil or more flammable refined oil of all sorts from agricultural products, equivalent products with or without refined process for running transportation of all kinds, as alcohol made from grain molasses or equivalents, alcohol, spirits, firewater, liquor, oil of all sorts, rubber plants of all sorts in place of gasoline, petroleum in my discovery using as well burning for producing electricity,
composition of flammable liquid; mixture having compositions of alcohol, compositions of spirits, compositions of firewater, compositions of liquor, compositions of oil, and/or equivalent products with or without refined process with any other liquid, material, chemical, gasoline, etc for transportation of all kinds.

6. Half and/or partly covered propeller blades being equipped rotating dynamos/generators atom by wind, by moving transportation, by wing of liquid and energy by sun burning, by volcano, by products, by energy plants from agricultural land for generating electricity being connected using for housing, industry, etc referring to claim 4 and Alcohol firewater, oil of all sorts from agricultural products burning for generating electricity and using as energy for running transportation of all kinds; all vehicles, engine-vehicles, motor-vehicles, automobiles, cars, trucks, buses, vans, trains, underground trains, trolley, motorcycles aircraft, helicopters space rockets, ships, submarines fleet, moving objects of all sorts referring to claim 5 wherein the original elements, composition connection, operation, function, structures, illustrations, process of making, production, installation, combination, extension and using of the invention, any other structures, modifications, facilities, limitations, substitutes, replacement of parts being assembled for performing both the same and similar formation referring to fundamentals of the original invention in these documents functioning to the same effect, combining the invention with any other machineries, devices, instruments, equipments, appliances, structures, systems, projects, objects, etc functioning to the same and/or similar outcome same or other names are in the scope of protection of the invention the invention used everywhere.
